(19) United States
(12) Patent Application Publication
(10) Pub. No.: US 2024/0051679 A1
(43) Pub. Date: Feb. 15, 2024

(54) Battery-Based Aircraft Performance and Operations

(71) Applicant: Joby Aero, Inc., Santa Cruz, CA (US)

(72) Inventors: Christabelle Bosson, Mountain View, CA (US); Eric Mueller, San Francisco, CA (US); Paul Snow, Capitola, CA (US); Aria Daniel Tedjarati, Menlo Park, CA (US); Bogu Wei, San Jose, CA (US)

(21) Appl. No.: 18/449,476

(22) Filed: Aug. 14, 2023

Related U.S. Application Data
(60) Provisional application No. 63/397,602, filed on Aug. 12, 2022.

(51) Int. Cl. B64D 45/00; G08G 5/00; G01C 21/34

(52) U.S. Cl. CPC B64D 45/00; G08G 5/003; G01C 21/3423; B64D 2045/0085

(57) ABSTRACT

Systems and methods for battery-based aircraft performance are provided. An example computer-implemented method includes accessing, by a computing system, flight plan data for a first flight. Based on the flight plan data, the computing system can compute a first expected power demand on the aircraft's battery system for the first flight. The computing system can access initial battery state data of the aircraft. The computing system can compute, using a battery model, a first capability output based the first expected power demand and the initial battery state. The first capability output can be indicative of a range/ToF of the aircraft for the first flight. The computing system can determine an ability of the aircraft to perform the first flight based on the first capability output and generate an itinerary accordingly. The computing system can transmit, over a network, instructions associated with implementing the itinerary for performance by the aircraft.

### RELATED APPLICATIONS

The present application claims the benefit of and priority to U.S. Provisional Patent Application No. 63/397,602, filed Aug. 12, 2022, which is hereby incorporated by reference in its entirety.

### FIELD

The present disclosure relates generally to improving the usage and modeling of aircraft energy storage systems within the context of a transportation service. For example, the present disclosure utilizes battery modeling technology to generate flight itineraries for aircraft based on energy storage capabilities, as well as to make real-time adjustments and displays while the aircraft are in-flight.

### BACKGROUND

Transportation service applications allow individual users to request transportation. For example, service providers can match drivers/vehicles to requests for transporting a rider to a requested destination or delivering packages, goods, or prepared foods. Computing platforms can be used to help facilitate these services.

### SUMMARY

Aspects and advantages of implementations of the present disclosure will be set forth in part in the following description, or may be learned from the description, or may be learned through practice of the implementations.

One example aspect of the present disclosure is directed to a computer-implemented method. The method includes accessing data associated with a first flight plan of a first flight. The method includes, based on the data associated with the first flight plan, computing a first expected power demand on an energy storage system of an aircraft for the first flight. The method includes accessing data indicative of an initial battery state of the energy storage system of the aircraft. The method includes computing, using a battery model, a first capability output based the first expected power demand on the energy storage system of the aircraft and the initial battery state of the energy storage system of the aircraft. The first capability output is indicative of a range or an available time of flight of the aircraft for the first flight. The method includes determining an ability of the aircraft to perform the first flight based on the first capability output. The method includes generating an itinerary for the aircraft based on the ability of the aircraft to perform the first flight. The method includes transmitting, over a network, instructions associated with implementing the itinerary for the aircraft.

In some example implementations, wherein it is determined that the aircraft is able to perform the first flight, generating the itinerary for the aircraft includes adding the first flight to the itinerary for the aircraft.

In some example implementations, wherein it is determined that aircraft is not able to perform the first flight, generating the itinerary for the aircraft includes omitting the first flight from the itinerary for the aircraft.

In some example implementations, the computer-implemented method further includes accessing data associated with a second flight plan of a second flight, computing a second expected power demand on the energy storage system of the aircraft based on the data associated with the second flight plan, accessing data indicative of a predicted future battery state of the aircraft, and computing, using the battery model, a second capability output based on the second expected power demand on the energy storage system of the aircraft and the predicted future battery state of the aircraft. The second capability output is indicative of a future range or a future available time of flight of the aircraft for the second flight.

In some example implementations, the computer-implemented further includes, based on the second capability output, updating the itinerary for the aircraft to include the second flight.

In some example implementations, the computer-implemented further includes, based on the second capability output, computing one or more charging parameters for charging the energy storage system of the aircraft between the first flight and the second flight.

In some example implementations, the charging parameters are indicative of at least one of: a target level of charge, a target temperature, or charging infrastructure.

In some example implementations, the computer-implemented method further includes determining whether to include the second flight in the itinerary for the aircraft based on the charging parameters.

In some example implementations, the predicted future battery state of the aircraft is computed by the battery model based on the first expected power demand on the energy storage system of the aircraft and the initial battery state of the energy storage system of the aircraft.

In some example implementations, the data associated with the first flight plan of the first flight is indicative of one or more aircraft maneuvers for performing the first flight.

In some example implementations, the data associated with the first flight plan of the first flight is indicative of at least one of: (i) a route, (ii) an altitude, (iv) an environmental condition, (v) a noise constraint, or (vi) a speed.

In some example implementations, the computer-implemented method further includes accessing data indicative of a current battery state of the aircraft while the aircraft is performing the first flight, computing, using the battery model, an updated capability output based on the current battery state of the aircraft and the battery model, and adjusting the itinerary of the aircraft based on the updated capability output.

In some example implementations, adjusting the itinerary of the aircraft based on the updated capability output includes at least one of: (i) adjusting a payload of the aircraft for a subsequent flight, (ii) adjusting one or more charging parameters for charging the aircraft after the first flight, or (iii) removing a subsequent flight from the itinerary of the aircraft.

In some example implementations, the first flight is associated with a multi-modal transportation service, the multi-modal transportation service includes a first transportation leg including a first ground transportation service from an origin, an intermediate transportation leg including the first flight, and a second ground transportation service to a destination.

Another example aspect of the present disclosure is directed to a computer-implemented method. The method includes accessing data associated with a flight plan of a flight currently being performed by an aircraft. The flight is associated with a multi-modal transportation service. The method includes computing an expected power demand on an energy storage system of the aircraft based on the data indicative of the flight plan. The method includes accessing data indicative of a current battery state of the energy storage system of the aircraft. The method includes computing, using a battery model, a predicted future battery state of the aircraft based on the expected power demand on the energy storage system of the aircraft and the current battery state of the energy storage system of the aircraft. The method includes accessing data associated with the multi-modal transportation service. The method includes determining an action associated with the multi-modal transportation service based on the predicted future battery state of the aircraft and the data associated with the multi-modal transportation service. The method includes transmitting, over a network, instructions indicative of the action associated with the multi-modal transportation service.

In some example implementations, the data associated with the multi-modal transportation service includes at least one of: an itinerary of the aircraft, data associated with one or more other aircraft associated with the multi-modal transportation service, or data associated with one or more users of the multi-modal transportation service.

In some example implementations, the action associated with the multi-modal transportation service includes at least one of: (i) an adjustment to the flight plan, (ii) an adjustment to an itinerary for the aircraft, (iii) an adjustment to an itinerary of another vehicle, (iv) an adjustment to an itinerary of a user, or (v) an adjustment to a ground transportation service.

In some example implementations, the computer-implemented method further includes determining one or more charging parameters for the aircraft based on the predicted future battery state of the aircraft, and determining the action associated with the multi-modal transportation service based on the one or more charging parameters.

Yet another example aspect of the present disclosure is directed to one or more non-transitory, computer-readable media storing instructions that are executable by one or more processors to cause the one or more processors to perform operations. The operations include accessing data associated with a flight plan of a flight. The operations include, based on the data associated with the flight plan, computing a power profile of an aircraft for the flight. The operations include computing, using a battery model, a capability output based on the power profile and data indicative of an initial battery state of the aircraft. The operations include generating an itinerary for the aircraft based on the capability output, wherein the itinerary is associated with a multi-modal transportation service. The operations include transmitting, over a network, instructions associated with implementing the itinerary for the aircraft.

In some example implementations, the power profile is indicative of an expected power demand on an energy storage system of an aircraft for the flight.

Other example aspects of the present disclosure are directed to other systems, methods, vehicles, apparatuses, tangible non-transitory computer-readable media, and devices for using battery modelling technology to generate and adjust aircraft itineraries and operations, as well as controlling aircraft and other vehicles associated therewith.

These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 depicts an example transportation service according to example implementations of the present disclosure;

FIG. 2 depicts a map diagram of an example transportation itinerary and aerial routes according to example implementations of the present disclosure;

FIG. 3 depicts a graphical representation of an example aerial facility according to example implementations of the present disclosure;

FIG. 4A depicts an example computing ecosystem for providing a transportation service according to example implementations of the present disclosure;

FIGS. 4B-C depict example computing device registers according to example implementations of the present disclosure;

FIG. 5 depicts an example vehicle provider ecosystem according to example implementations of the present disclosure;

FIG. 6 depicts an example aircraft according to example implementations of the present disclosure;

FIG. 7A depicts an example energy storage system of an aircraft according to example implementations of the present disclosure;

FIG. 7B depicts an example onboard computing system of an aircraft according to example implementations of the present disclosure;

FIG. 8 depicts a block diagram of a computing system with various data according to example embodiments of the present disclosure;

FIG. 9 depicts a flowchart diagram of an example algorithm for generating an itinerary according to example embodiments of the present disclosure;

FIG. 10 depicts a flowchart diagram of an example data flow according to example embodiments of the present disclosure;

FIG. 11 depicts a flight path and a flowchart diagram of an example data flow for making real-time operational adjustments according to example embodiments of the present disclosure;

FIG. 12 depicts a computing device with an example user interface according to example embodiments of the present disclosure;

FIGS. 13A-17B depict flowchart diagrams of example methods according to example implementations of the present disclosure; and

FIG. 18 depicts a block diagram of an example computing system according to example embodiments of the present disclosure.

### DETAILED DESCRIPTION

Generally, the present disclosure is directed to improving the usage and modeling of aircraft energy storage systems within the context of a transportation service. This includes using battery modeling technology to better generate flight itineraries for electric aircraft based on their energy storage and usage capabilities, as well as make real-time adjustments while the electric aircraft are in-flight.

For instance, a service entity can coordinate an end-to-end multi-modal transportation service for a plurality of users. The multi-modal transportation service includes transportation of a user and/or a user's cargo from an origin to a destination via multiple transportation legs, involving multiple, different types of transportation modalities. This can include, for example, a user traveling via a ground vehicle for an initial transportation leg, an aircraft for an intermediate transportation leg, and another ground-based vehicle for a last transportation leg. The aircraft utilized to provide the aerial transportation leg can include electric-powered aircraft such as, for example, electric vertical take-off and landing vehicles (“eVTOLs”).

When generating pre-flight itineraries for aircraft, it is desirable to understand the flight time or range that a particular aircraft can travel given the current (or predicted) flight conditions. Additionally, during operation, flight conditions may change in real-time impacting an aircraft's available flight time or range, as well the timing and coordination of the other transportation legs of the multi-modal transportation service.

Where the energy is petroleum-based fuel, estimated flight time/range can be calculated based on the average miles per gallon (and in turn average time per mile based on the planned speed) that the aircraft is rated for. For electric-based powertrains, however, performing the same calculation is not possible or effective due to a variety of reasons, including the nonlinear nature of the energy supply and because achievable performance is not solely related to the amount of charge stored in the battery.

The present disclosure utilizes battery modeling technology to better generate flight itineraries for aircraft based on the aircraft's specific energy storage capabilities, as well as make real-time adjustments while the aircraft are in-flight. For example, a computing system (e.g., a cloud-based computing platform of the service entity) can obtain flight plan data descriptive of various parameters of a flight. Using the flight plan data, the computing system can determine a power profile that identifies an expected power demand on an energy storage system of an aircraft for the flight.

The computing system can utilize this information to determine whether the aircraft can perform the flight. For example, the computing system can input the power profile, as well as data indicative of an initial battery state of the aircraft, into a battery model. The battery model can be configured to compute a range or an available time of flight for the aircraft based on the expected power demand on the aircraft's energy storage system.

The battery model can output such data as a capability output, which can allow the computing system to determine whether the aircraft is able to perform the flight given its initial battery state. For example, if the aircraft is able to perform the flight, the computing system can add the flight to an itinerary of the aircraft. The aircraft's itinerary can be a data structure that stores the various flights assigned to the aircraft along with other information such as destinations, departure times, flight duration, arrival times, routes, charging parameters, etc. The computing system can continue to iteratively evaluate subsequent flights, as well as the charging parameters needed to re-charge the aircraft's energy storage system between flights, to build-out a custom itinerary for the aircraft given its particular energy storage capabilities.

The computing system can also leverage the battery modeling technology of the present disclosure to determine real-time adjustments to the aircraft's itinerary, while the aircraft is in-flight. For example, the computing system can determine that based on the predicted battery state of the aircraft, the aircraft may need additional charging time at the destination aerial facility. Accordingly, the computing system may transmit instructions to remove or replace a subsequent flight in the aircraft's itinerary to provide the aircraft sufficient charging time.

In the context of a multimodal trip, the computing system can also adjust the timing of a subsequent transportation leg to help provide a seamless transition for a passenger. By way of example, given a delay in an arrival time (e.g., due to increased charging time), the computing system can adjust a matching queue to ensure that a ground vehicle is available for a passenger after the flight leg and that the vehicle is able to transport the passenger to the ultimate destination within the preferred time-of-arrival. In this way, the battery technology of the present disclosure can improve the usage/performance of the energy resources of electric aircraft as well as the efficiency of the operations of an associated multi-modal transportation service.

In some implementations, an aircraft pilot can be presented with real-time information indicating the potential impact that a change in flight maneuver may have on the overall multi-modal transportation service. For example, a display system onboard the aircraft can present an aircraft's predicted range and remaining flight time, as computed using the battery modeling technology.

The display system can present information indicating a potential impact that changing the flight maneuvers may have on the multi-modal transportation service. The display system can present thresholds or other UI elements that help indicate battery levels, below which the operations of the multi-modal transportation service may be impacted. For example, by using these thresholds, a pilot can determine that changing the flight path, landing approach, speed, etc. would result in additional charging time needed at the next aerial facility and delay the departure of a next flight. This can allow a pilot to better understand the overall impact of a flight maneuver and help improve real-time control decisions to minimize the effects on the overall multi-modal transportation operations.

The technology of the present disclosure can provide a number of technical effects and improvements to computing and aircraft technology. For instance, the technology of the present disclosure can compute an expected power draw for the aircraft given a certain flight plan. A battery model can ingest this information along with battery state data associated with a specific aircraft to determine the range/available time of flight of an aircraft at various times along a flight. In this way, the technology of the present disclosure provides an improved approach for automatically predicting future battery states in a manner that is specifically tailored to a particular flight plan as well as the specifications of an aircraft and its energy storage system (e.g., vehicle/battery specifications and capabilities, charge, capacity, type, age, wear, tendencies, etc.). This allows the battery model to predict the future operating state of an aircraft and its energy storage system more accurately. As a result, a computing system can utilize the battery model to implement a customized solution for automatically generating itineraries that are specifically tailored for the aircraft based on its onboard energy storage capabilities.

As described herein, the technology of the present disclosure also provides an improved approach for making intelligent, real-time itinerary adjustments that better account for the performance of the aircraft and its batteries. Moreover, a computing system can better generate and implement charging plans that are tailored to the aircraft. Accordingly, the technology of the present disclosure reduces the degradation of an energy storage system of an aircraft, thus increasing the lifespan of the energy storage system.

### Example Transportation Service

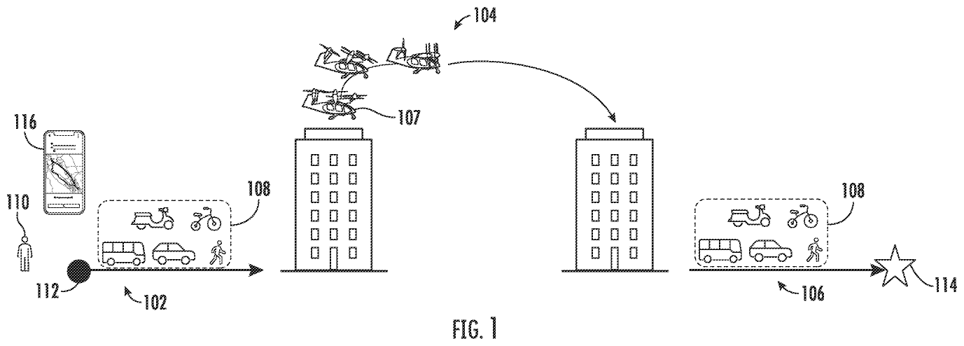

FIG. 1 depicts an example process flow of a transportation service according to example implementations of the present disclosure. The transportation service can be or otherwise include a multi-modal transportation service. A multi-modal transportation service can include multiple transportation legs 102, 104, 106 associated with at least two different transportation modalities. For example, the multi-modal transportation service can include a first transportation leg 102, one or more second transportation legs 104, and a third transportation leg 106.

A combination of ground vehicles, aircraft, or other types of vehicles can perform the various legs of the multi-modal transportation service. Each transportation leg of the multi-modal transportation service can be associated with a respective transportation modality. For instance, the first transportation leg 102 can be associated with a first transportation modality using one or more of ground vehicles 108 such as an automobile. A second transportation leg 104 can be associated with a second transportation modality using an air-based modality such as an aircraft 107. The third transportation leg 106 can be associated with a third transportation modality, which can be the same or different from the first or second modalities. For example, the third transportation leg 106 can use a ground modality such as another automobile, bicycle, walking route, etc.

The aerial transport can include one or more different aircraft such as airplanes, vertical take-off and landing vehicles (“VTOLs”), or other aircraft including conventional take-off and landing vehicles (“CTOLs”). VTOLs, for example, can include one or more different types of rotorcraft (e.g., helicopters, quadcopters, gyrocopters, etc.), tilt-rotor aircraft, powered-lift vehicles, and/or any other vehicle capable of vertically taking-off and/or landing (e.g., without a runway).

As shown in FIG. 1, the aircraft used in the multi-modal transportation service can include a VTOL that is configured to operate in multiple flight modes. For example, an aircraft can include multirotor configurations such that the position, orientation, etc. of the aircraft's rotors can be adjusted to allow the aircraft to operate in the various flight modes. This can include, for example, a first rotor position that allows the aircraft to take-off, land, or hover vertically and a second rotor position that allows the aircraft to travel forward (e.g., “cruise”) using a thrust force.

The aircraft can include one or more types of power sources such as batteries, a combustible fuel source, electrochemical sources (such as a hydrogen fuel cell system), or a combination thereof. For example, the aircraft can include electric VTOLs (“eVTOLs”) capable of operating using one or more electric batteries, VTOLs capable of operating using combustible fuel, or VTOLs using hybrid propulsion systems.

The multi-modal transportation service can be provided in an on-demand manner. The service can include a ridesharing, ride-hailing, vehicle reservation, or delivery service. The multi-modal transportation service can be coordinated for a user 110 by one or more service providers.

A service provider can be an entity that offers, coordinates, manages, etc. a transportation service. This can include a transportation network company, vehicle fleet manager, etc. For example, a user 110 may desire to travel on a journey from an origin location 112 to a destination location 114. The user 110 can interact with a user device 116, via a user interface of a software application, to book transportation for the journey. The user 110 can interact with user device 116 over one or more user sessions.

Based on the user sessions, at least one service entity can compile one or more options for the user 110 to traverse the journey. The user device 116 of the user 110 may present these options to the user 110 via a user interface of the software application. At least one option for the journey can include the multi-modal transportation service. Responsive to selection of the multi-modal transportation service option by the user 110, the service can be initiated for transportation for user 110.

To track and coordinate the multi-modal transportation service, a user itinerary can be computed for the user 110. A user itinerary (also referred to as a “multi-modal itinerary”) can be defined by a data structure that includes various information associated with a user's trip from an origin location to a destination location. As used herein, user itinerary may refer to the user itinerary or the underlying data structure depending on the context. The user's itinerary may include: identifiers for locations of interest (e.g., names/coordinates for origins, destinations, vertiports, etc.), times/durations the user is at each location, transportation modalities, specific vehicle assignments, seat assignments, real-time location data, luggage information, or other information. The user itinerary can be updated in real-time as the user 110 progresses along the journey, in response to any changes to the journey, etc. The user itinerary can be available to the user 110 via the user device 116.

Building user itineraries on-demand across modalities can involve centralized or distributed scheduling of resources associated with each modality. For instance, example implementations can involve systems and devices that interface with user 110, systems and devices associated with a first modality of transportation, and systems and devices associated with a second modality of transportation.

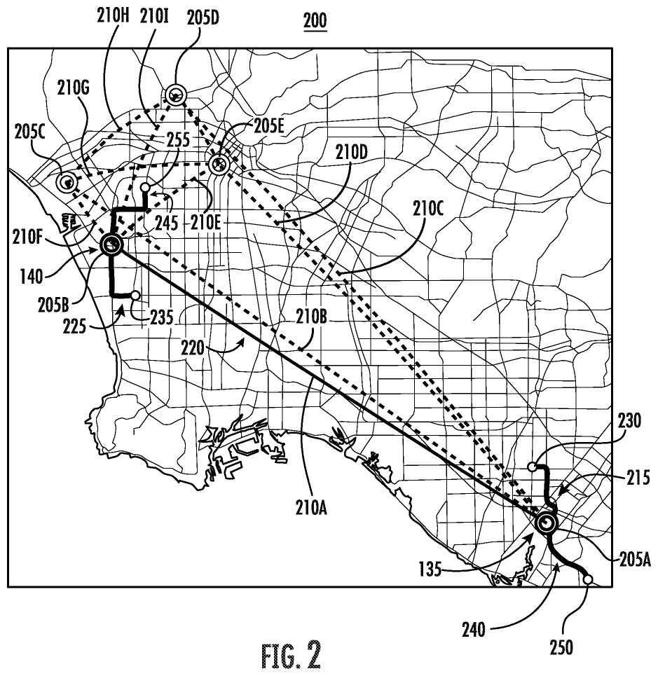

The itinerary of the user 120 can be based on the user's origin location, destination location, available intermediate locations for transitioning between transportation modalities, vehicle routes, and/or other information. For example, FIG. 2 depicts a graphical map diagram of an example multi-modal transportation service within a geographic area 200 according to example implementations of the present disclosure. The geographic area 200 can be, for example, an urban environment.

The geographic area 200 can include a network of intermediate locations that can be used for transitioning a user from one transportation modality to another. For instance, the geographic area 200 can include a plurality of aerial facilities 205A-E. The aerial facilities 205A-E (e.g., vertiports) can allow a user to transition from a ground transportation modality to an aerial transportation modality, or vice versa. The plurality of aerial facilities 205A-E can be placed at various locations within the geographic area 200. The plurality of aerial facilities 205A-E can be connected by a plurality aerial routes 210A-J. In some implementations, the aerial routes 210A-J can be designed with respect to airspace constraints (e.g., noise constraints, air traffic constraints, etc.). In some implementations, demand modeling can be performed to select high value infrastructure locations for placing the plurality of aerial facilities 205A-E throughout the geographic area 200 and generating routes 210A-J between the aerial facilities 205A-E, without interfering with the airspace constraints. This network of aerial facilities 205A-E and routes 210A-J can be utilized to create flight plans for aircraft used within the multi-modal transportation service 100 to indicate how and where a particular aircraft may travel through an operational time period.

Multiple users can be pooled together for multi-modal transportation services, such that different user itineraries can share at least one transportation leg. This can include pooling users to share an intermediate transportation leg (e.g., a flight on an aircraft), even though the users may have different origin or destination locations.

By way of example, a first user itinerary for a first user can include three transportation legs 215, 220, and 225 (shown in bold in FIG. 2). The first user itinerary can include transporting the first user from a first origin location 230 to a first intermediate location (e.g., aerial facility 205A) to a second intermediate location (e.g., aerial facility 205B) and, ultimately, to a first destination location 235. The first and second intermediate locations can be determined based on their proximity (e.g., being the closest aerial facilities) to the first origin location 230 and the first destination location 235, respectively. The first user itinerary can include ground transportation modalities (e.g., cars, etc.) along the first and last transportation legs 215, 225 and an aerial transportation modality (e.g., VTOLs) along the intermediate transportation leg 220.

A second user itinerary for a second user can include three transportation legs 240, 220, and 245 (shown in bold in FIG. 2). The second user itinerary can include transporting the second user from a second origin location 250 to the first intermediate location (e.g., aerial facility 205A) to the second intermediate location (e.g., aerial facility 205B) and, ultimately, to a second destination location 255. The second user itinerary can include ground transportation modalities along the first and last transportation legs 240, 245 and an aerial transportation modality along the intermediate transportation leg 220.

The first user and the second user can be pooled together for the intermediate transportation leg 220. For example, the first user itinerary and the second user itinerary can respectively indicate that the first user and the second user are to travel in the same flight of an aircraft traveling along route 210A, to transport the users between aerial facility 205A and aerial facility 205B. In this manner, the first and second users can share at least one transportation leg for cost and power efficient multi-modal transportation.

### Example Aerial Facility

The intermediate locations within a multi-modal transportation service can be configured to help seamlessly transition users from one transportation leg or modality to another. As described herein, these intermediate locations can include aerial facilities for facilitating the take-off (e.g., departure) and landing (e.g., arrival) of aircraft utilized in a multi-modal transportation service.

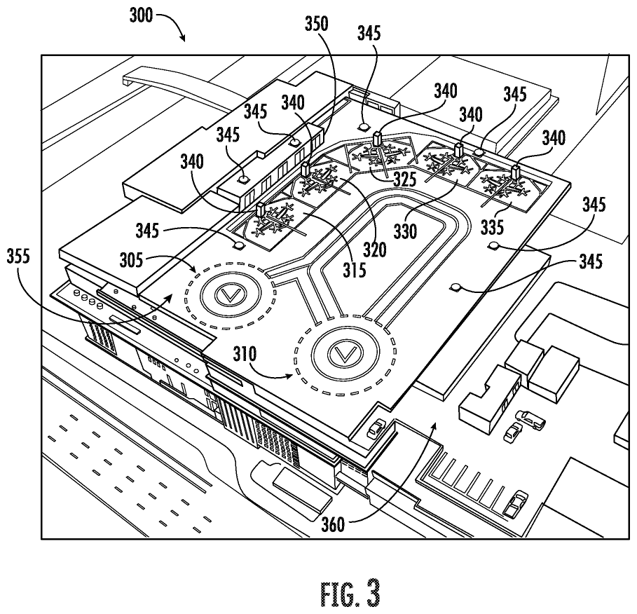

By way of example, FIG. 3 depicts a graphical diagram of an example aerial facility 300 according to example implementations of the present disclosure. The aerial facility 300 can include a vertiport with one or more final approach and landing pads 305, 310 (e.g., FATO pads), one or more vehicle parking locations 315-335, or other infrastructure for maintaining and facilitating the functions of aircraft (e.g., VTOLs). For example, the aerial facility 300 can include infrastructure 340 which can include hardware and software for refueling or recharging an aircraft between flights. Various portions of the infrastructure 340 can be accessible at one or more of the vehicle parking locations 315-335.

The aerial facility 300 can include a structure or area for transitioning a user to and from an aerial transportation leg of a multi-modal transportation service. The aerial facility 300 can be located in a geographic area where multi-modal transportation services are offered. For instance, the aerial facilities can include a building or designated area within a geographic environment. In some implementations, the aerial facility 300 can be a portion (e.g., a roof, dedicated floors, etc.) of a building or structure that may be used for other purposes (e.g., commercial, residential, industrial, parking, etc.).

The aerial facility 300 can include one or more sensors 345. The sensors can include visual, audio, or other types of sensors. For example, the sensors can include cameras, microphones, vibration sensors, motion sensors, RADAR sensors, LIDAR sensors, infrared sensors, temperature sensors, humidity sensors, other weather condition sensors, etc. The sensors 345 can be configured to obtain sensor data (e.g., noise data, weather data, aircraft-related data, etc.) within and around the aerial facility 300.

The aerial facility 300 can include one or more output devices. The output devices can include display screens, speakers, lighting elements, or other infrastructure to communicate information to users, facility operators, vehicle operators, or other individuals at the aerial facility 300. For example, display screens can be utilized to indicate an aircraft assigned to a user and a parking location assigned to an aircraft. The aerial facility 300 can include paths for users to travel to and/or from aircraft. In some implementations, the output devices (e.g., lighting elements) can help indicate the paths to the users.

The aerial facility 300 can include charging infrastructure configured for charging or otherwise servicing the energy storage system of an aircraft. For example, the aerial facility 300 can include chargers that are configured to physically connect with the aircraft at a charge port. The chargers can provide charge to the batteries of the aircraft, to increase the charge level of the aircraft. The aerial facility 300 can include various types of chargers to accommodate various types of aircraft, types/configurations of charge points, types/configurations of batteries, etc.

The charging infrastructure can also include systems for battery conditioning. This can include, for example, systems for thermal management of the batteries of an aircraft. The thermal management systems may cool the temperature of the aircraft batteries. The battery temperature may be cooled to a target temperature for the aircraft to perform a subsequent flight. The target temperature may be based on the specification of the batteries, the parameters of the subsequent flight, the downtime of the aircraft, etc.

In some implementations, the charging infrastructure may include one or more other systems for monitoring battery health and status. This can include systems that are configured to run diagnostics on the aircraft batteries to detect any anomalies, damage, etc.

The aerial facility 300 can include one or more access points 350 for user ingress and egress. The access points 350 can include designated areas, elevators, stairwells, etc. The access points 350 can also help users to transition between transportation legs and the different modalities associated therewith. For example, after being dropped-off at the aerial facility 300 by a ground vehicle for a first transportation leg, a user can utilize an access point 350 to enter an area 355 for checking-into a flight for the next transportation leg, an area for boarding an aircraft, etc. After unloading from the aircraft at the aerial facility 300, a user can utilize an access point 350 to access an area 360 for boarding a ground vehicle for a last transportation leg.

An aerial facility 300 can be operated by various entities. For example, a service entity that manages a fleet of aircraft and/or coordinates a transportation service can own, control, operate, etc. the aerial facility 300. In some implementations, the aerial facility 300 can be owned, controlled, operated, etc. by a third-party facility provider. The third-party facility provider may not have its own aircraft fleet but may operate the aerial facility 300 and/or permit other entities to utilize the aerial facility 300.

The aerial facility 300 can be utilized by a single entity or shared among a plurality of entities. For example, a service entity that manages/operates a fleet of aircraft can own, lease, control, operate, etc. the entire aerial facility 300. The service entity and its associated fleet may exclusively utilize the aerial facility 300, such that aircraft outside the service entity's fleet are not permitted at the aerial facility 300, except in emergency circumstances. In another example, a first service entity that manages/operates a first fleet of aircraft can share the aerial facility 300 with a second service entity that manages/operates a second fleet of aircraft. In some implementations, certain resources at the aerial facility 300 can be assigned to a particular fleet or service entity. For example, a first set of landing pads, parking pads, infrastructure, storage areas, waiting areas, etc. can be designated for the first service entity and its associated fleet. A second set of landing pads, parking pads, infrastructure, storage areas, waiting areas, etc. can be designated for the second service entity and its associated fleet. In some implementations, the resources at the aerial facility 300 can be shared such that the shared resources can be assigned dynamically, throughout an operational time period based on user/aircraft itineraries, charging needs, etc.

The aerial facility 300 can include an aerial facility computing system, not shown in FIG. 3. The aerial facility computing system can be configured to monitor and control the various resources of the aerial facility 300. This can include, for example, monitoring and controlling infrastructure such as chargers, sensors, output devices, etc. The aerial facility computing system can include one or more computing devices and can communicate with other computing systems and devices associated with the multi-modal transportation service.

### Example Computing Ecosystem for a Transportation Service

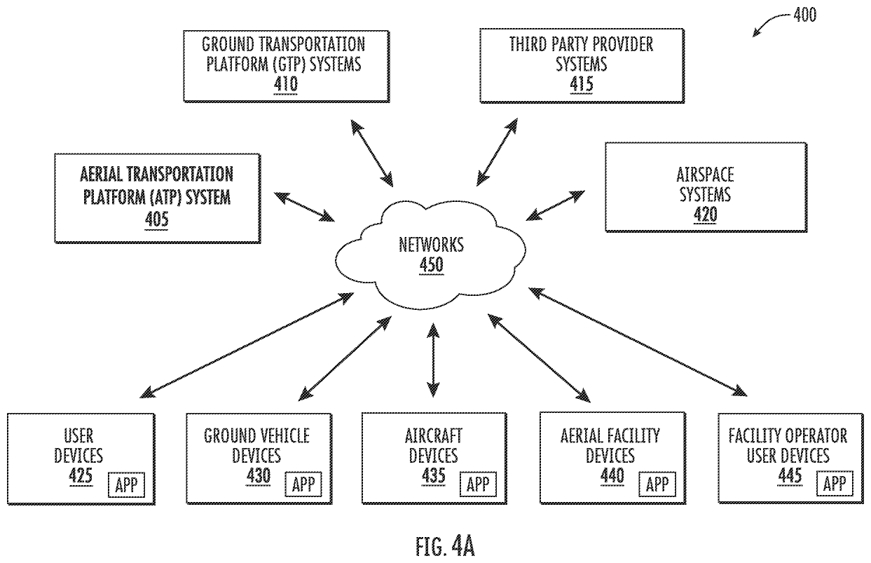

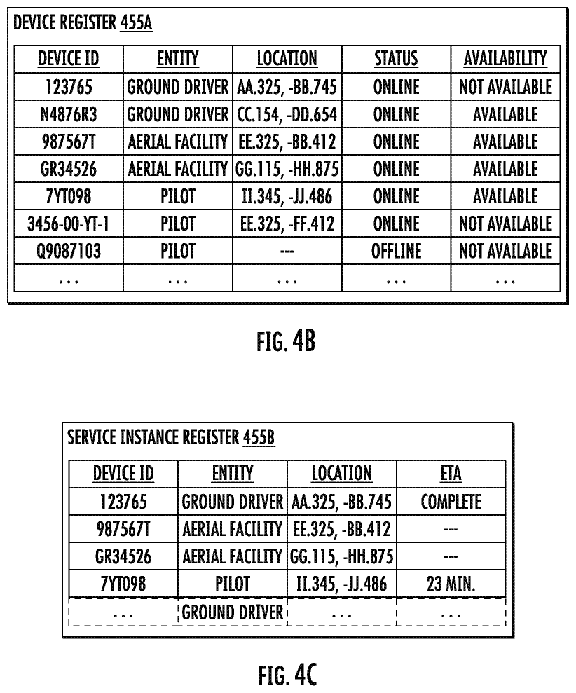

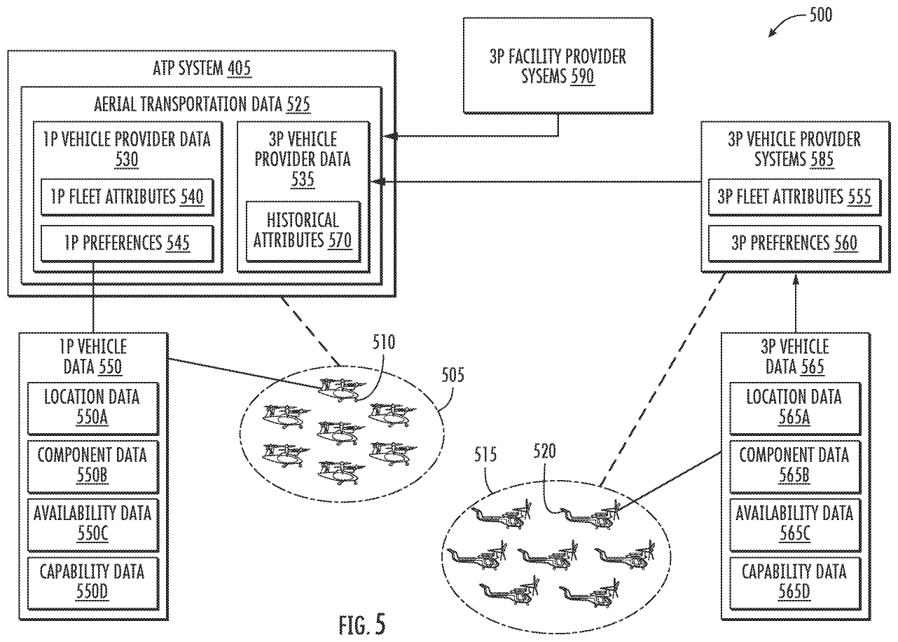

FIG. 4A depicts a block diagram illustrating an example networked ecosystem 400 for cross-platform coordination for transportation services (e.g., multi-modal transportation service). Multiple network-connected systems can cooperatively interact within ecosystem 400 to provide multimodal transportation services. As shown, the ecosystem 400 may include a distributed computing system with a plurality of different participating systems/devices communicatively connected over one or more networks 450.

The ecosystem 400 can include one or more transportation platform systems such as, for example, an aerial transportation platform (ATP) system 405 and one or more ground transportation platform (GTP) systems 410. The ecosystem 400 can include third-party provider systems 415, airspace systems 420, user devices 425, ground vehicle devices 430, aircraft devices 435, aerial facility devices 440, or facility operator user devices 445.

Each of the systems or devices can communicate over one or more wireless or wired networks 450. Networks 450 can include one or more types of networks including telecommunications networks, internet, private networks, or other networks, as further described herein.

The systems and devices of ecosystem 400 can include a plurality of software applications operating on the respective systems and devices. This can create an ecosystem of applications for providing and coordinating a multimodal transportation service, as further described herein.

User devices 425 can include computing devices owned or otherwise accessible to a user of a transportation service. For example, a user device 425 can include a hand-held computing device (e.g., a phone, a tablet, etc.), a wearable computing device (e.g., smart watch, smart glasses, etc.), personal desktop devices, or other devices. User devices 425 can execute one or more instructions to run an instance of a software application for a respective transportation platform and present user interfaces associated therewith. User devices 425 can include personal devices (e.g., a mobile device) or shared devices on which a user has initiated a personal session (e.g., by logging into a public kiosk or display device in a vehicle, etc.).

A GTP system 410 can be associated with a service entity that provides a ground transportation service. GTP systems 410 can include a computing platform (e.g., a cloud services platform, server system, etc.) communicatively connected over networks 450 to one or more of the systems or devices of networked ecosystem 400.

GTP systems 410 can include or implement one or more client-facing software applications accessible to the devices of ecosystem 400. Users can interact with the GTP systems 410 (e.g., using user devices 425, ground vehicle devices 430, aircraft devices 435) to receive various types of transportation services (e.g., delivery, ridesharing, or ride-hailing, etc.) including the multimodal transportation services described herein. For example, a GTP system 410 can match one of its associated ground vehicles or operators with users for a ground transportation service.

GTP systems 410 can be associated with ground infrastructure for facilitating the performance of a ground transportation service. The ground infrastructure can include one or more parking areas, vehicle transfer hubs, charging/fueling locations, storage facilities, etc.

GTP systems 410 can be associated with a fleet of ground vehicles and the vehicle operators can include a network of ground vehicle operators. As described herein, ground vehicles can include automobiles, bikes, scooters, autonomous vehicles, etc. The network of ground vehicle operators can include drivers or remote operators that facilitate, oversee, or control the movement of ground vehicles available to perform ground transportation services.

Ground vehicle devices 430 can include computing devices or systems associated with a ground vehicle or operator. For example, ground vehicle devices 430 can include one or more vehicle computing systems such as, for example, an onboard computer for operating the vehicle, an autonomy system, an infotainment system, etc. Additionally, or alternatively, ground vehicle devices 430 can include an operator's user device. For example, a ground vehicle device can be a driver's mobile phone. In some implementations, ground vehicle devices 430 can include a user device that remains onboard a ground vehicle such as, for example, a tablet that is available to an operator or passenger.

An ATP system 405 can be associated with one or more service entities that provide at least an aerial transportation service to users. ATP system 405 can include a computing platform (e.g., a cloud services platform, server system, etc.) communicatively connected over networks 450 to one or more of the systems or devices of networked ecosystem 400.

ATP systems 405 can include or implement one or more client-facing software applications accessible to the devices of ecosystem 400. Users can interact with ATP system 405 (e.g., using user devices 425, ground vehicle devices 430, aircraft devices 435) to receive various types of information related to a transportation service. For example, a user (e.g., a rider) can interact with ATP system 405 via an instance of a software application (e.g., a rider app) running on user device 425 to request and book a multimodal transportation service. A facility operator can interact with ATP system 405 via an instance of a software application (e.g., an operations app) running on an aerial facility device 440 or a facility operator user device 445 to view/adjust flight information, seat assignments, etc.

ATP systems 405 can be associated with one or more aircraft, aircraft operators, aerial facilities (or portions thereof), facility operators, etc. for facilitating the performance of at least an aerial transportation service. For example, the aircraft can include a fleet of aircraft and the vehicle operators can include a network of aircraft operators. The network of aircraft operators can include pilots or remote operators that facilitate, oversee, or control the movement of aircraft available to perform aerial transportation services.

Aerial facilities used for providing a transportation service can include one or more aerial facility devices 440. Aerial facility devices 440 can be positioned at various locations within or around the aerial facility to collect and receive information associated with an aerial transportation service. Aerial facility devices 440 can include one or more charging devices associated with charging infrastructure of the aerial facility, one or more vehicle positioning devices (e.g., motorized tugs, etc.), one or more sensors or surveillance devices (e.g., noise sensors, cameras, etc.), etc.

Facility operators can be associated with an aerial facility to assist users with security checks, check-ins, boarding/de-boarding, performing aircraft checks, etc. The facility operator user devices 445 can include user devices utilized by the facility operators. Facility operator user devices 445 can be used to communicate with a transportation platform or perform various functions at an aerial facility. For example, facility operator user devices 445 can run one or more software applications to complete security checks, check in/out luggage, coordinate re-charging/re-fueling, present safety briefings, or the like.

Aircraft devices 435 can include one or more aircraft computing systems or aircraft operator user devices. For instance, aircraft devices 435 can include a computing system onboard an aircraft such as a pilot interface, an avionics system, an infotainment system, a navigation system, an autonomy system, or any other sensors or devices located on an aircraft and capable of sending or receiving information. Aircraft devices 435 can include an aircraft operator's user device (e.g., a pilot's mobile phone). Aircraft devices 435 can include a user device that remains onboard the aircraft such as, for example, a tablet or display that is available to a passenger or operator.

The ecosystem 400 can include one or more airspace systems 420. Airspace systems 420 can include one or more airspace data exchanges or otherwise be associated with regulatory bodies configured to collect real-time, historical, or regulatory airspace data. The airspace systems 420 can include, for example: (i) aggregating systems that pool airspace data associated with an airspace; (ii) third-party monitoring systems configured to monitor aspects of an airspace (e.g., noise, etc.); or (iii) regulatory systems that can confirm, validate, or approve an aerial transportation service before take-off based on one or more policies or standards set by a regulatory body (e.g., Federal Aviation Administration, European Aviation Safety Agency, etc.).

The ecosystem 400 can include one or more third-party provider systems 415. Third-party provider systems 415 can be associated with one or more third parties that provide resources to ATP systems 405 or GTP systems 410. For example, third-party provider systems 415 can be associated with a third-party aircraft provider, including one or more “third-party” aircraft. Third party aircraft can include aircraft provided, leased, loaned, or otherwise made available by an entity for use by ATP systems 405 for transportation services, as further described herein.

Additionally, or alternatively, third-party provider systems 415 can be associated with a provider of one or more third-party aircraft operators. Third-party aircraft operators can include, for example, a plurality of aircraft pilots that may be available to ATP systems 405 for operation of an aircraft for the transportation services.

In some implementations, third-party provider systems 415 can be associated with a third-party facility provider that can provide facilities (or facility resources) for use in performing transportation services. For example, the third-party facility provider can own, operate, etc. one or more aerial facilities (or portions thereof) that can be rented, leased, or otherwise utilized by a transportation platform system for providing an aerial transportation service. ATP systems 405 or GTP systems 410 can communicate directly or indirectly (e.g., through third-party provider systems 415) with the third-party aircrafts, operators, or infrastructure.

The systems and devices of ecosystem 400 may be registered for potential use when providing and coordinating a multimodal transportation services. FIG. 4B illustrates an example device register 455A. Device register 455A can include a table or other data structure indicating devices/systems participating in the on-demand transportation platform ecosystem, such as ecosystem 400. Device register 455A can include fields such as Device ID, Entity, Location, Status, Availability, etc.

The device register 455A can be maintained in a local or remote database. Systems and devices can register for participation in ecosystem 400 by providing information to a registration service. Such information can include system/device identifiers, associated entities, IP addresses, downloading an application, signing-up or creating an account, or other information for identifying and communicating with the system/device. The device register 455A can be updated to provide a real-time reference for the characteristics and status of participating systems/devices. This can include, for example, determining whether a device is online or offline (e.g., powered on and connected, or not) or whether the device is available (e.g., not currently being utilized for another task) or unavailable (e.g., being utilized for another task).

When building a user itinerary, a service instance register can be created, such as an example service instance register 455B shown in FIG. 4C. A service instance register can include a data structure with one or more data objects that indicate the devices to be utilized for facilitating and progressing a user along their journey.

An ATP system 405 (or another system) can build a service instance register 455B for servicing a particular service request. Service instance register 455B can be associated with a unique or distinct service instance identifier for a particular user itinerary for providing at least one leg of a transportation service. Service instance register 455B can assemble a selection of participating devices from device register 455A. Service instance register 455B can include a minimum set of participating devices to complete at least a leg of a journey. Service instance register 455B may include all participating devices to complete the entire leg of a journey.

The ATP system 405 (or another system) can update and reconfigure service instance register 455B as needed to accommodate for scheduling changes, delays, device substitution, etc. or as the journey/itinerary progresses for a particular user. For example, as the user progresses along a second leg of a particular journey, the he ATP system 405 (in communication with a GTP system 410) may identify and select a ground vehicle for servicing the last leg of the user's journey. In response, the ground vehicle device associated with the selected ground vehicle can be listed in the service instance register 455B. In this manner, service instance registers 455B can accurately reflect the systems/devices of the ecosystem 400 that are associated with each particular service instance for the users of the multi-model transportation service.

### Example Aircraft Ecosystem

As discussed herein, the aerial transportation platform system 405 and the ground transportation platform system 410 can plan and fulfill transportation services, such as multi-modal transportation services. The orchestration of a transportation service can be performed in a number of different implementations. For example, in a single orchestrator implementation, a transportation platform system can receive a request and orchestrate a multi-modal transportation service. In a multi-orchestrator implementation, a combination of transportation platforms can collaborate to orchestrate the multi-modal transportation service. This can include the use of aircraft from multiple different entities.

FIG. 5 depicts an example aerial transportation ecosystem 500 according to example embodiments of the present disclosure. The aerial transportation ecosystem 500 includes the ATP system 405 and one or more 3P vehicle provider systems 585.

The ATP system 405 can be associated with a “first-party” (1P) aircraft fleet 505. The 1P aircraft fleet 505 can include a plurality of 1P aircraft 510 owned, maintained, operated, or otherwise affiliated with the ATP system 405. A 1P aircraft 510 can include an eVTOL owned by the entity that operates the ATP system 405.

The one or more 3P vehicle provider systems 585 can be associated with a 3P aircraft fleet 515. The 3P aircraft fleet 515 can include a plurality of 3P aircraft 520 owned, maintained, operated, or otherwise affiliated with the 3P aircraft fleet 515. 3P aircraft can be those that are outside of the dedicated fleet of “first-party” aircraft. For example, a 3P vehicle provider can decide to make its 3P aircraft available to the ATP system 405 to perform transportation services, at certain times. However, the 3P vehicle provider may maintain ownership or some level of control over 3P aircraft.

The ATP system 405 can communicate with the 1P aircraft 510 or the 3P vehicle provider systems 585 to access at least a portion of the aerial transportation data 525. The aerial transportation data 525, for example, can include 1P vehicle provider data 530 and 3P vehicle provider data 535.

The 1P vehicle provider data 530 can include one or more 1P fleet attributes 540, one or more 1P preferences 545, or 1P vehicle data 550.

The 1P fleet attributes 540 can identify one or more types of aircraft or any other attributes associated with the aircraft within the 1P aircraft fleet 505. By way of example, the 1P aircraft fleet 505 can include one or a plurality of different types of aircraft. Each different type of aircraft can be associated with one or more different aircraft attributes. Aircraft of a certain vehicle type can be associated with one or more common aircraft attributes. By way of example, a vehicle type can include a large vehicle type with a high payload capacity at the expense of speed, a small vehicle type with a low payload capacity and high speed, a luxury vehicle, a high speed vehicle, etc. In some implementations, the 1P fleet attributes 540 can identify one or more overhead costs (e.g., fixed costs, etc.) for maintaining the 1P aircraft fleet 505 or one or more opportunity costs afforded by the 1P aircraft fleet 505.

The 1P preferences 545 can indicate one or more preferences of the ATP system 405 for the performance of an aerial transportation service. The 1P preferences 545, for example, can identify an operational time period, service type (e.g., delivery, ride-share, etc.), weather conditions, geographic locations, aerial facilities, or any other attribute of a transportation service that can assist the ATP system 405 in scheduling 1P aircraft 510 for flights. As one example, an operational time period can identify a time during which the ATP system 405 prefers to use the 1P aircraft 510 to perform a transportation service. In some implementations, the 1P preferences 545 can identify attributes of a transportation service such as longer flight times, shorter flight times, types of vehicle maintenance (e.g., charging times, etc.), or any other aspect of a transportation service.

The 1P vehicle data 550 can be indicative of one or more aircraft attributes associated with each of the 1P aircraft 510 of the 1P aircraft fleet 505. By way of example, the aircraft attributes can include location data 550A, component data 550B, availability data 550C, or capability data 550D for each of the 1P aircraft 510 of the 1P aircraft fleet 505. The ATP system 405 can communicate with the 1P aircraft 510 to access the 1P vehicle data 550.

The location data 550A, for example, can identify a current, predicted, or historical location of the 1P aircraft 510. The location data 550A can be determined through one or more messages exchanged between the aerial transportation platform system 405 and the 1P aircraft 510. For instance, the location data 550A can be determined based on sensor data (e.g., GPS data, RADAR data, etc.) from one or more sensors onboard the 1P aircraft 510. As another example, the location data 550A can be determined based on one or more flight plans assigned to the 1P aircraft 510, etc.

The component data 550B can identify the types of components of the 1P aircraft. A component can include, for example, one or more hardware or software components for each of the plurality of 1P aircraft 510. The hardware components can include at least one power component (e.g., an engine, fuel tank, battery, etc.), climate control component, navigation component, flight control component, etc. The one or more software components can include one or more software applications (e.g., an operating system, a user interface, etc.) associated with each of the plurality of 1P aircraft 510.

The component data 550B can be indicative of the types, numbers, sizes, positions, orientations, etc. of the propulsion systems of the 1P aircraft 510. This can include, for example, indicating the positions, numbers, and types of rotors on a 1P aircraft 505. The component data 500B can indicate the maneuverability of the components. For example, the component data 550B can indicate which (if any) rotors are moveable/tiltable, their range of motion (e.g., by angle, position), and the timing constraints for adjusting the angle/position of the rotors.

The component data 550B can identify a current, predicted, or historical state for each aerial component of the 1P aircraft 510. The state can identify a health, power level, current software version, etc. of each of the one or more components. As one example, a current state of a power component can identify a current power level or range for each of the 1P aircraft 510. In some implementations, the current power level or range can include a dynamic variable that depends on characteristics associated with candidate flight plans.

In some implementations, the 1P aircraft 510 can include electric aircraft powered by one or more batteries. The component data 550B for an electric aircraft can include battery data indicative of a current, historical, or predicted condition of the one or more batteries. The battery data, for instance, can be indicative of a plurality of battery characteristics for the batteries. The battery characteristics can identify operating conditions of the batteries as well as a battery configuration and type.

Battery operating conditions can be indicative of a maximum capacity of the batteries at a particular time. The maximum capacity of the batteries can be based on a battery type, configuration, etc. of the batteries onboard the 1P aircraft 510. The maximum capacity can change over time based on a number of dynamic battery characteristics including, for example, a battery's age, usage history, or any other characteristic associated with the battery's capacity to hold power. For example, the maximum capacity of the batteries onboard the 1P aircraft 510 can decrease over time as the batteries age or degrade.

The battery operating conditions can also be indicative of a current state of charge (SoC) or a future, predicted SoC of the batteries onboard the 1P aircraft 510. The SoC of the batteries can indicate a level of power accessible to the 1P aircraft 510 at a particular time. The SoC can be based on a level of charge or a temperature of the batteries. The level of charge can be a function of and depend on the maximum capacity of the batteries. For instance, the level of charge can identify a percentage of the maximum capacity that is available to the 1P aircraft 510 at a particular time. The battery operation conditions can also indicate the state of health of the batteries of the 1P aircraft 510.

The battery operating conditions can be based on a battery model for a battery of an electric aircraft. The battery model can include one or more charging parameters (e.g., types of charges (e.g., slow, fast, etc.), infrastructure necessary to service the battery (standardized charging interfaces, etc.), and a range model configured to determine a range for a respective battery based on the battery's SoC or any other factor that may affect the performance of the battery.

The availability data 550C can identify a current, predicted, or historical assignment (e.g., a service assignment, a maintenance assignment, etc.) for the 1P aircraft 510. For example, the availability data 550C can be indicative of usage information (e.g., historical usage, current usage, expected usage, etc.) for the 1P aircraft 510. The usage data can be indicative of historical, current, or expected flights, maintenance, or any other tasks associated with a respective aircraft.

The capability data 550D can be associated with one or more constraints or capabilities of a respective 1P aircraft 510. For example, the capability data 550D can include at least one of a payload capacity (e.g., maximum allowable payload, weight, etc.), a seating capacity (e.g., a maximum number of passengers per flight), a performance history (e.g., miles flown, historic performance on trips for the service entity or other service providers), one or more vehicle control parameters (e.g., operational capabilities such as turning radius, lift, thrust, or drag capabilities), one or more speed parameters (e.g., maximum, minimum, or average speed, etc.), or one or more maintenance requirements (e.g., infrastructure required to perform maintenance, refueling, etc. for the aircraft, etc.).

In some implementations, the capability data 550D can indicate the flight modes of the 1P aircraft 510. For instance, the capability data 550B can indicate that a 1P aircraft 505 is capable of flying in a cruise mode, transition mode, hover mode, energy efficient mode, etc.

The capability data 550D can indicate the energy efficiency of the 1P aircraft 510 when operating in the respective flight modes. For example, the capability data 550D can include look-up tables that indicate the energy efficiency (e.g., charge or fuel burn rate) of a respective 1P aircraft 505 when operating in a cruise mode. The energy efficiency while operating in the cruise mode may include an energy profile developed during testing of the 1P aircraft 505 (or another aircraft in the fleet of 1P aircraft 510). The energy efficiency of the 1P aircraft 505 while operating in the cruise mode may be associated with the position/angle of the aircraft's propulsion system (e.g., for forward thrust), its operating speed (e.g., circular velocity), etc.

The capability data 550D can include look-up tables that indicate the energy efficiency (e.g., charge or fuel burn rate) of the respective 1P aircraft 505 when operating in a hover mode. The energy efficiency while operating in the hover mode may include an energy profile developed during testing of the 1P aircraft 505 (or another aircraft in the fleet of 1P aircraft 510). The energy efficiency of the 1P aircraft 505 while operating in the hover mode may be associated with the position/angle of the aircraft's propulsion system (e.g., for lift), its operating speed (e.g., rotational velocity), etc. Operating in the hover mode may cause the 1P aircraft 505 to consume more energy from its batteries than operating in the cruise mode.

The capability data 550D can include look-up tables that indicate the energy efficiency (e.g., charge or fuel burn rate) of the respective 1P aircraft 505 when operating in a transition mode. The energy efficiency while operating in the transition mode may include an energy profile developed during testing of the 1P aircraft 505 (or another aircraft in the fleet of 1P aircraft 510). The energy efficiency of the 1P aircraft 505 while operating in the transition mode may be provided in associated with various positions/angles of the aircraft's propulsion system (e.g., for lift), its operating speeds, etc.

In some implementations, the capability data 550D can be indicative of operator capabilities associated with an operator of the 1P aircraft 510 (e.g., a pilot rank, designated operating areas, seniority, rating, etc.).

The capability data 550D can dynamically change based on the component data 550B or other real-time information such as weather conditions, etc. This information can be monitored (e.g., by an onboard system or offboard system) and updated in real-time to maintain a database that accurately reflects the aircraft.

The ATP system 405 can communicate with the 3P vehicle provider systems 585 to access the 3P vehicle provider data 535. The 3P vehicle provider data 535 can include 3P fleet attributes 555, 3P preferences 560, or 3P vehicle data 565. The 3P fleet attributes 555, the 3P preferences 560, or the 3P vehicle data 565 can include similar types of information for the 3P aircrafts 520 as any of the example 1P fleet attributes 540, 1P preferences 545, or 1P vehicle data 550 described herein. By way of example, the 3P vehicle data 565 can include location data 565A, component data 565B, availability data 565C, or capability data 565D as described with reference to the location data 550A, component data 550B, availability data 550C, and capability data 550D of the 1P vehicle data 550. The 3P vehicle provider systems 585 can communicate with the 3P aircraft 520 to access the 3P vehicle data 565.

In some implementations, the 3P vehicle provider data 535 can include 3P historical attributes 565. The 3P historical attributes 565 can be indicative of one or more historical interactions between the 3P vehicle provider systems 585 and the aerial transportation platform system 405. For example, the 3P historical attributes 565 can be indicative of one or more previous aerial transportation services provided by the 3P vehicles 520. The 3P historical attributes 565 can be indicative of a reliability, a willingness to perform various types of aerial transportation services, service time constraints met or exceeded, user reviews, etc. of the 3P vehicle provider systems 585.

As described herein, a computing system can leverage the aerial transportation data 525 to plan and facilitate a plurality of flights. The plurality of flights can be performed using electric aircraft powered by a plurality of batteries. The operation of such aircraft can depend on the state of the charge for the batteries.

### Example Aircraft and Aircraft Energy Storage Systems

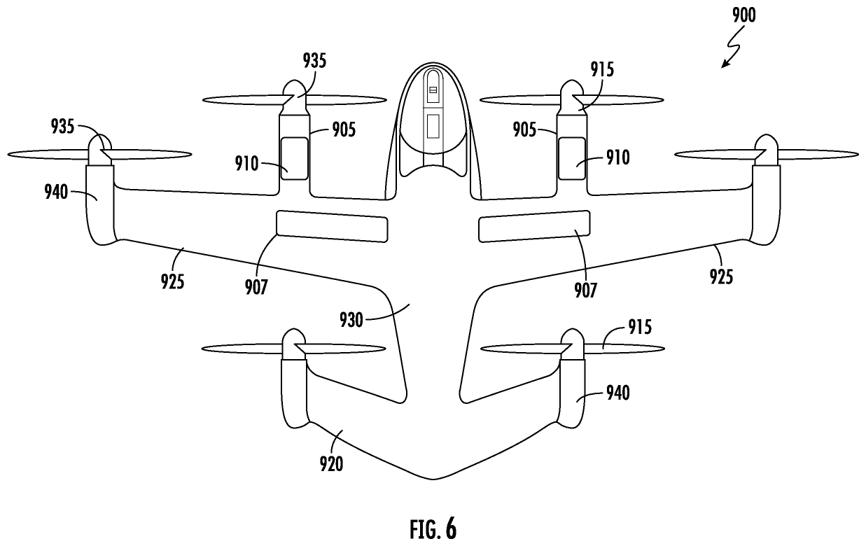

FIG. 6 depicts an example aircraft 900 according to example implementations of the present disclosure. The aircraft 900 can be a VTOL aircraft that can perform a vertical lift and hover maneuver (e.g., to take-off and land) as well as perform a forward cruise maneuver. This can be accomplished by a moveable propulsion system such as, for example, rotor assemblies 935 that tilts/rotates to cause a lift force in one position and a thrust force in another position.

The aircraft 900 can include a fuselage 930, two wings 925, an empennage 920 and propulsion systems 915 embodied as tiltable rotor assemblies 935 located in nacelles 940.

The aircraft 900 includes one or more energy storage systems. The energy storage systems can include, for example, a nonlinear power source such as nacelle battery packs 910 or wing battery packs 907. In the illustrated example, while the nacelle battery packs 910 are located in inboard nacelles 905, it will be appreciated that the nacelle battery packs 910 can be located in other nacelles 940 forming part of the aircraft 900.

The aircraft 900 can include associated equipment such as an electronic infrastructure, control surfaces, a cooling system, landing gear and so forth. The aircraft 900 can include a charge port for receiving battery charge from a charger.

The wings 925 function to generate lift to support the aircraft 900 during forward flight. The wings 925 can additionally or alternately function to structurally support the battery packs 907 or propulsion systems 915 under the influence of various structural stresses (e.g., aerodynamic forces, gravitational forces, propulsive forces, external point loads, distributed loads, and/or body forces, and so forth).

The aircraft 900 can be configured to operate in one or more flight modes. The flight modes may be associated with different positions of the propulsion systems 915, nacelles 905, 940, and/or portion thereof.

The flight modes can include a hover mode. In the hover mode, the propulsion systems 915 (or an associated portion thereof) can be oriented in a first position/angle to create a lift force on the aircraft 900. This can allow the aircraft 900 to hover, such that lateral movement may be reduced. In an example, the hover mode can be utilized by the aircraft 900 to hover when the aircraft is waiting or landing at a particular vertiport.

The flight modes can include a cruise mode. In the cruise mode, the propulsion systems 915 (or an associated portion thereof) can be oriented in a second position/angle to create a forward thrust force on the aircraft 900. In an example, the cruise mode can be utilized by the aircraft 900 to create forward propulsion such that the aircraft can travel along a particular route for a flight.

The flight modes can include a transition mode. In the transition mode, the propulsion system 915 (or an associated portion thereof) may move from one position or angle to another. This may occur, for example, to transition the propulsion system 915 from a first position (e.g., for hover mode) to a second position (e.g., for cruise mode). Movement of the propulsion system 915 may include movement of a nacelle 905, 940 or a portion thereof (e.g., tilt assembly). The transition mode may include the dynamic movement of propulsion system 915 between two positions and/or the propulsion system 915 being in a static position (e.g., a tilt angle between the first and second position) for a time period.

In some implementations, aircraft 900 can be configured to operate in flight modes for energy efficiency. Such modes may include adjusting one or more components of the aircraft to conserve energy. This may include, for example, adjusting the operating speed of a propulsion system 915, powering down certain on-board functions (e.g., interior lights), etc.

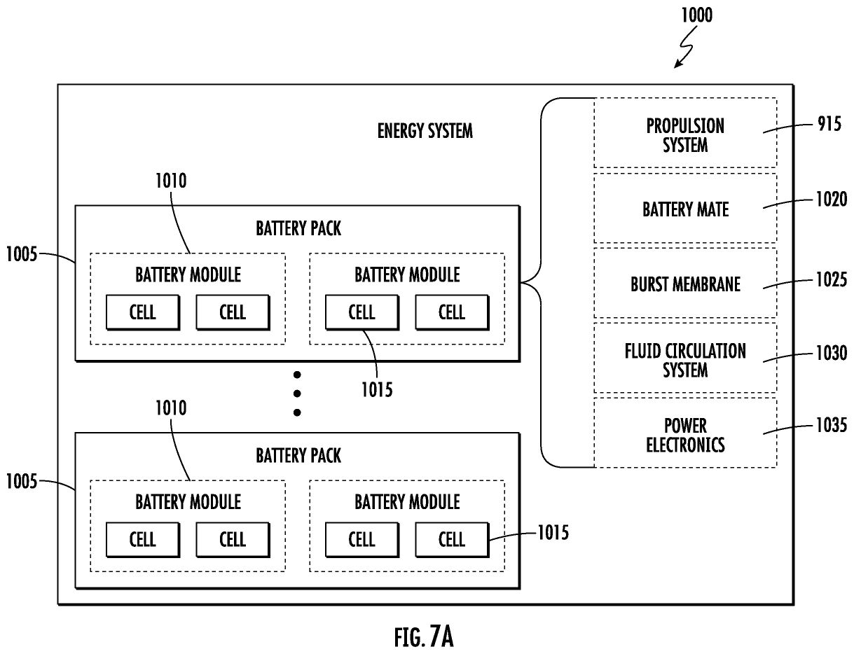

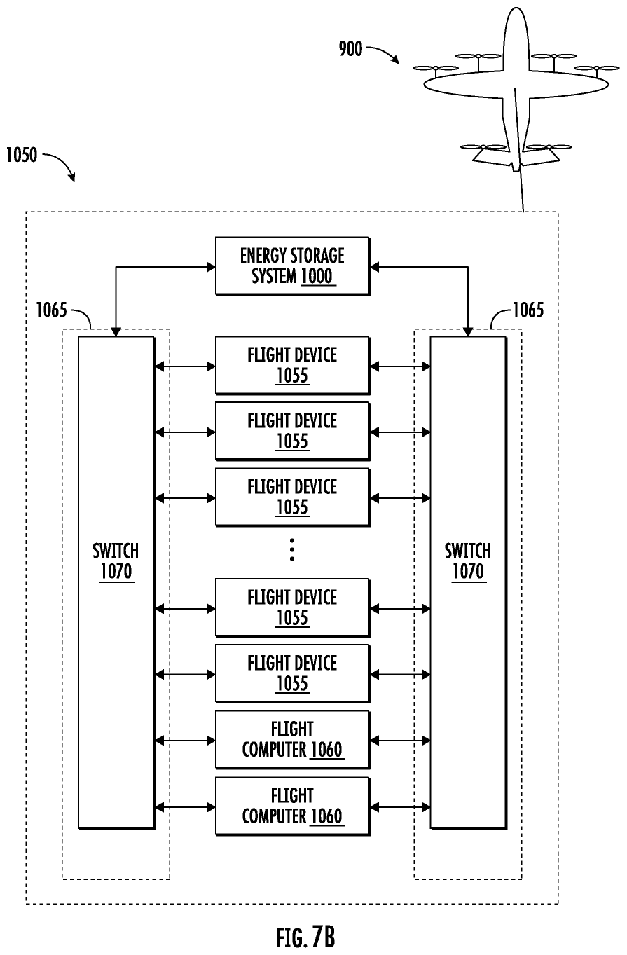

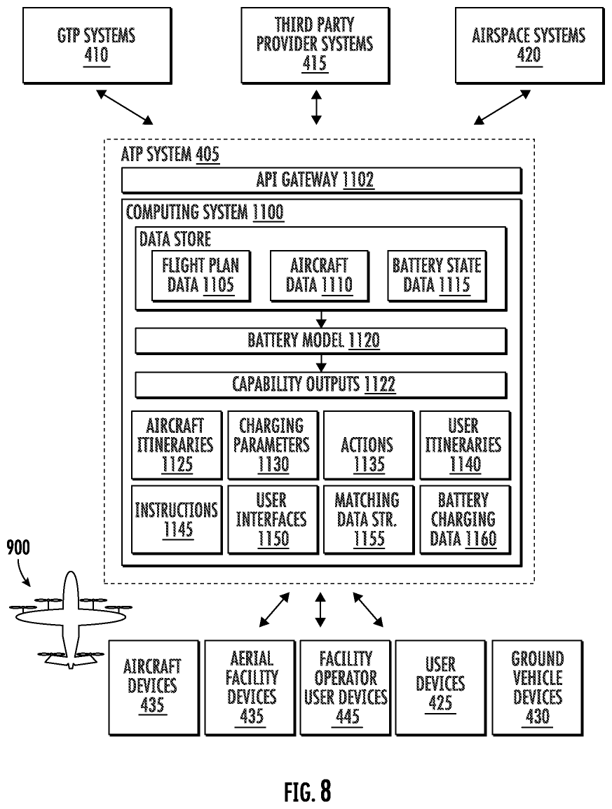

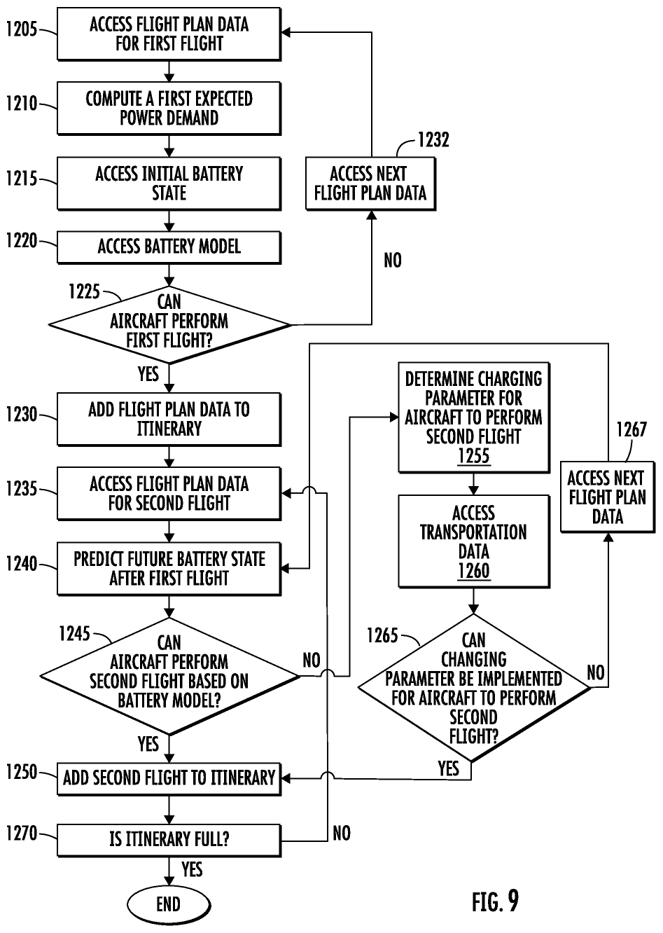

FIG. 7A is a schematic view of an aircraft energy storage system 1000 according to some examples. As shown, the energy storage system 1000 includes one or more battery packs 1005. Each battery pack 1005 can include one or more battery modules 1010, which in turn may comprise a number of cells 1015.

Various hardware can be associated with a battery pack 1005. This can include, for example: one or more propulsion systems 915, a battery mate 1020 for connecting it to the energy storage system 1000, a burst membrane 1025 as part of a venting system, a fluid circulation system 1030 for cooling, or power electronics 1035 for regulating delivery of electrical power (from the battery during operation and to the battery during charging) and to provide integration of the battery pack 1005 with the electronic infrastructure of the energy storage system 1000.

The electronic infrastructure and the power electronics 1035 can additionally or alternately function to integrate the battery packs 1005 into the energy storage system 1000 of the aircraft. The electronic infrastructure can include a Battery Management System (BMS), power electronics (high-voltage (HV) architecture, power components, and so forth), low-voltage (LV) architecture (e.g., vehicle wire harness, data connections, and so forth), or any other suitable components. The electronic infrastructure can include inter-module electrical connections, which can transmit power or data between battery packs or modules. Inter-modules can include bulkhead connections, bus bars, wire harnessing, or any other suitable components.

The battery packs 1005 can function to store electrochemical energy in a rechargeable manner for supply to the propulsion systems 915. Battery packs 1005 can be arranged and/or distributed about the aircraft in any suitable manner. Battery packs can be arranged within wings (e.g., inside of an airfoil cavity), inside nacelles, or in any other suitable location on the aircraft.

In a specific example, the system includes a first battery pack within an inboard portion of a left wing and a second battery pack within an inboard portion of a right wing. In a second specific example, the system includes a first battery pack within an inboard nacelle of a left wing and a second battery pack within an inboard nacelle of a right wing. Battery packs 1005 may include a plurality of battery modules 1010.

The energy storage system 1000 can optionally include a cooling system (e.g. fluid circulation system 1030) that functions to circulate a working fluid within the battery pack 1005 to remove heat generated by the battery pack 1005 during operation or charging. Battery cells 1015, battery module 1010 and/or battery packs 1005 can be fluidly connected by the cooling system in series and/or parallel in any suitable manner.

FIG. 7B illustrates an electrical architecture 1050 for the aircraft 900. The electrical architecture 1050 can include the energy storage system 1000, one or more flight devices 1055, one or more flight computers 1060, and a distribution network 1065. Network 1065 includes a number of switches 1070 and appropriate wired or wireless data-transmission links within the network 1065 and with the other components of the electrical architecture 1050.

The electrical architecture 1050 can function to provide redundant and fault-tolerant power and data connections between the flight devices 1055, flight computers 1060, and the energy storage system 1000. The flight devices 1055 can include any components related to aircraft flight, including for example actuators and control surfaces, such as ailerons, flaps, rudder fins, landing gear, sensors (e.g., kinematics sensors, such as IMUs; optical sensors, such as cameras; acoustic sensors, such as microphones and radar; temperature sensors; altimeters; pressure sensors; and/or any other suitable sensor), cabin systems, and so forth.

The flight computers 1060 can control the overall functioning of the aircraft 900. For example, the flight computers 1060 can interpret and transform flight data into commands that can be transmitted to and interpreted by controllable flight components. Data may be commands, aircraft state information, or any other appropriate data. Aircraft state information may include faults (e.g., a fault indicator, fault status, fault status information, etc.); sensor readings or information collected by flight components such as speed, altitude, pressure, GPS information, acceleration, user control inputs (e.g., from a pilot or operator), measured motor RPM, radar, images, or other sensor data; component status (e.g., motor controller outputs, sensor status, on/off, etc.), energy storage system 1000 state information (battery pack 1005 voltage, level of charge, temperature and so forth); or any other appropriate information. Commands may include faults (e.g., a fault indicator, fault status, fault status information, etc.); control commands (e.g., commanding rotor RPM or other related parameter such as torque, power, thrust, lift, etc., data to be stored, commanding a wireless transmission, commanding display output, etc.); or any other appropriate information.

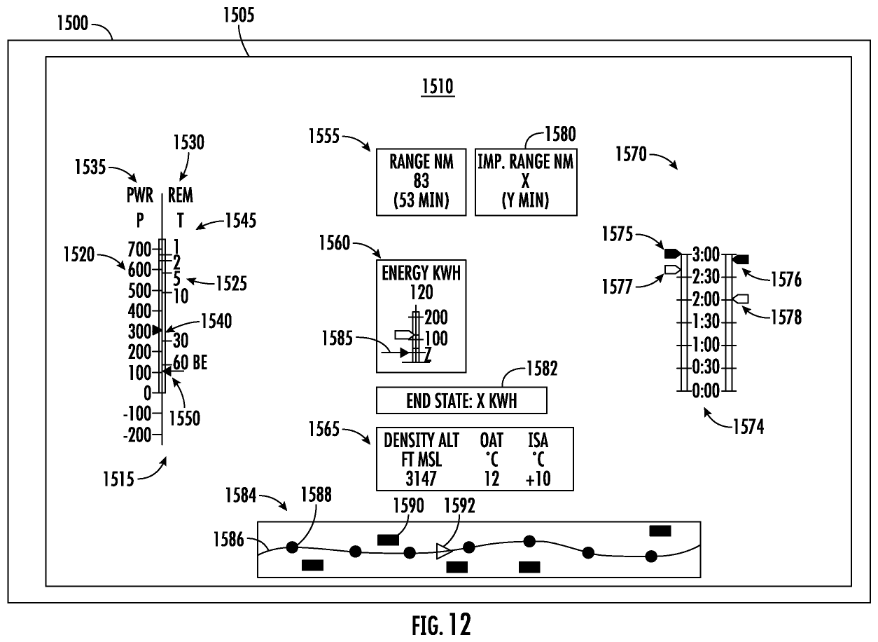

I/O components can be included with the flight computers 1060. The I/O components can be used to receive input from and provide output to a pilot or other operator. I/O components may for example include a joystick, inceptor or other flight control input device, data entry devices such as keyboards and touch-input devices, and one or more display devices (e.g., screens or other hardware capable of presenting a user interface) for providing flight and other information to the pilot or other operator. FIG. 12 shows an example I/O component in the form of a display device.

### Example Battery-Based Aircraft Performance and Operations

The technology of the present disclosure can improve the usage and modeling of the energy storage systems of aircraft 900 within the context of a transportation service. For example, with reference to FIG. 8, given the aircraft's current or future battery state, a computing system 1100 can analyze one or more flight plans to help compute a customized aircraft itinerary for the aircraft 900. The computing system 1100 can also, or alternatively, facilitate the presentation of information (e.g., onboard aircraft 900) and make real-time operational changes based on the current or future battery state of the aircraft 900.

The computing system 1100 may be included within the ATP system 405 or another system configured for flight or charge planning for aircraft. For example, ATP system 405 can include a backend system that hosts a plurality of services (e.g., microservices). The ATP system 405 may include a graph that aggregates across the services. Each respectively programmed to perform a function for the ATP system 405.

The computing system 1100 may represent the implementation of one or more services of the backend system. For instance, the ATP system 405 may coordinate aerial transportation. The back-end services of the ATP system 405 may perform functions for generating flights, coordinating charging for those flights, generating aircraft itineraries, generating user interfaces, and making real-time adjustments to the transportation service. The computing system 1100 may include computing hardware that implements one or more services for evaluating candidate flights, generating aircraft itineraries, assigning electric aircraft to flights, coordinating charging, providing data to be displayed via user interfaces, instructing devices for service adjustments, etc. As described herein, the services may collect real-time data to perform their respective functions.

In some implementations, the computing system 1100 may be separate from the ATP system 405. The computing system 1100 may transmit a communication to the ATP system 405 to request data. For instance, the ATP system 405 (or an entity associated therewith) may publish a software development kit (SDK) that allows another computing system to structure messages according to the APIs of the ATP system 405. The structured messages may include requests for data such as, for example, a request for candidate flights, flight information/plans, etc.

The ATP system 405 may receive a structured message at an API gateway 1102. The API gateway 1102 may be configured to validate access to the requested data and orchestrate a call to each service that would be needed to provide the requested data. The API gateway 1102 may validate a message through a security layer that includes functions for message validation. By way of example, the API gateway 1102 may validate a message by determining that required request parameters (e.g., in the URI, query string, headers) of an incoming request are included and non-blank and/or the applicable request payload adheres to a configured scheme request model of the security layer. When the validation fails, the API gateway 1102 may fail the request and return an error response to the caller computing system. In the event a message is validated, the API gateway 1102 can call one or more services to gather and compile data to respond to the request. This can include utilizing the services implemented via computing system 1100.

In some implementations, the computing system 1100 can be a system that can provide data to the ATP system 405. The computing system 1100 can include one or more APIs via which the ATP system 405 can request the data or back-end service functions described herein and shown in FIG. 8.

The computing system 1100 can access: flight plan data 1105, aircraft data 1110, battery state data 1115, and a battery model 1120. Flight plan data 1105 can include data associated with one or more flight plans. A flight plan can include one or more data structures that store various parameters associated with performing a flight. The data structures can include structured data fields (e.g., such as an object having a class data type defined in a programming language), look-up tables, lists, trees, arrays, etc. The parameters stored within the data structure can include a route, aircraft maneuvers (e.g., take-off maneuver, landing maneuver, hover maneuver, cruise maneuver), altitudes, environmental conditions, noise constraints, speeds, etc. at an origin, destination, or therebetween for the associated flight. A flight plan can include related times (e.g., take-off/landing times), locations (e.g., departure/destination locations, waypoints), or other information associated with the flight.

The battery state data 1115 can include data indicative of a state of a battery. This can include state of charge (e.g., the level of charge of an electric battery relative to its rated capacity (%)) or state of health (e.g., the ratio of the maximum battery charge to its rated capacity (%)). The battery state data 1115 can include flight range, available time of flight, other health information, usage history, charge rate, etc. As further described herein, the battery model 1120 can be configured to predict the performance of an energy storage system such as, for example, the batteries onboard the aircraft 900.

Such information can help the computing system 1100 compute (e.g., computationally determine, generate, output, adjust, update, etc.): one or more aircraft itineraries 1125, one or more charging parameters 1130, one or more actions 1135 associated with a transportation service, implementation instructions 1140, one or more user itineraries 1145, one or more user interfaces 1150, data structures (e.g., matching data structure 1155), or other data, as further described herein.

Using the battery model 1120, the computing system 1100 can iteratively analyze flight plan data 1105 to compute an aircraft itinerary 1125 of the aircraft 900. More particularly, the computing system 1100 can be configured to generate aircraft itineraries 1125 for a fleet of aircraft (e.g., eVTOLs) used in the provision of a transportation service (e.g., multi-modal transportation service). As further described herein, the battery model 1120 can be utilized to generate one or more capability outputs 1122 that indicate the capability of the aircraft 900 (e.g., in terms of flight time, range, etc.) given the expected demand on the aircraft's batteries.

An aircraft itinerary 1125 can include one or more data structures indicative of various information associated with an aircraft's performance of a portion/leg of a multi-modal transportation service. For example, an aircraft itinerary 1125 for the aircraft 900 can include one or more flights assigned to the aircraft 900, charging parameters 1130 (e.g., charging times, levels, temperatures, voltages, currents, infrastructure, rates etc.) for charging an energy storage system of the aircraft 900 before/between/after flights, locations (e.g., origin/destination aerial facilities, landing pads, parking areas, etc.), aircraft states (e.g., charging, boarding, ready for take-off, taking-off, in route, hovering, landing, etc.), payload information (e.g., weight, type, number of users/items, etc.), associated times, or other information.

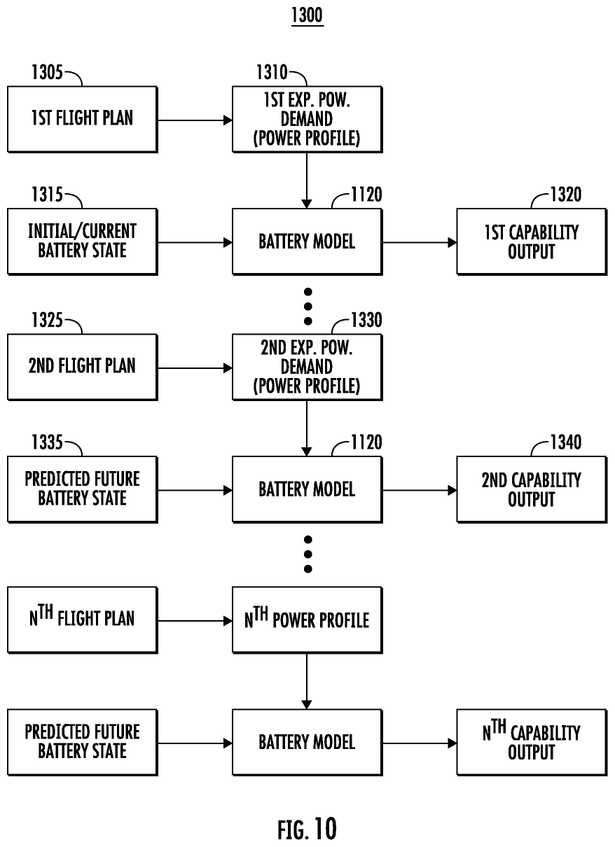

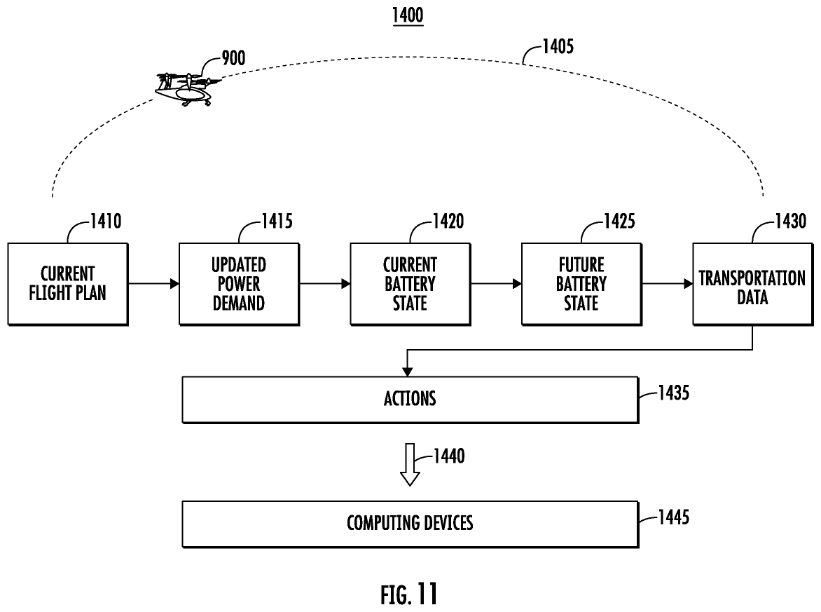

Reference will now be made to FIGS. 9 and 10 to describe an example algorithmic process for computing aircraft itineraries 1125.

FIG. 9 depicts a flowchart diagram 1200 of an example method for computing an aircraft itinerary according to example embodiments of the present disclosure. FIG. 10 depicts an example data flow 1300 for iteratively analyzing flight plans using the battery model 1120 according to example embodiments of the present disclosure.

To help generate the itinerary 1125 for an aircraft 900, at (1205), the computing system 1110 can access flight plan data 1105 associated with a first flight. The first flight can include a first candidate flight that is being evaluated for inclusion in the itinerary 1125 of the aircraft 900. The first candidate flight may be a future flight that is already scheduled. In some implementations, the first candidate flight may be a potential flight to be created, in an on-demand manner, based on demand for transport from users of a multi-modal transportation service. In some implementations, the first candidate flight may be a flight that is predicted by (or recommended by) a computing system to occur at a future time. This prediction can be based on historic flight data and historic demand for flights between the associated vertiports/locations.

The flight plan data 1105 for the first flight can be indicative of a first flight plan 1305. The first flight plan 1305 can be defined by one or more data structures that store various parameters associated with performing the first flight. This can include a route, vehicle maneuvers, altitudes, environmental conditions, noise constraints, speeds, etc. at an origin, destination, or therebetween for the first flight. The computing system 1125 can access the data structures of the flight plan data 1105 by searching, querying, requesting, pulling, etc. the flight plan data 1105 from a database or memory where the data is stored.

At (1210), the computing system 1100 can compute an expected power demand 1310 of the aircraft 900 for the first flight based on the flight plan data 1105 associated with the first flight plan 1305. More particularly, the expected power demand 1310 can be a predicted power demand value for one or more batteries of an aircraft based on the parameters of the flight plan and the particular aircraft. This can include an amount of power predicted to be drawn from the energy storage system. For example, for a flight plan, an expected power demand can be determined from parameters of the aircraft (e.g., weight, rotor configuration, shape), parameters at the origin and destination (e.g., altitude, outside air temperature, hover times, approach maneuvers), in-flight parameters/conditions (e.g., flight maneuvers, intended cruising altitude, cruising speed, wind direction), taxi time, etc.

To help compute the first expected power demand 1310, the computing system 1100 can access data indicative of aircraft specifications for the aircraft 900. The aircraft specifications can be stored in an accessible data structure that is indicative of characteristics of the aircraft 900 or its energy storage system. This can include aircraft weight, shape, size, propulsion, payload capacity, battery type, battery configuration, battery capacity, etc.

The computing system 1100 can determine one or more aircraft operating conditions at a plurality of times along the flight plan. For example, the computing system 1100 can parse the flight plan to determine at each of a plurality of times: the desired aircraft attitude, speed, location, etc.

The computing system 1100 can access data corresponding a power draw on the energy storage system of the aircraft 900 to the operating conditions. For instance, the computing system 1100 can access a data structure (e.g., look-up table, graph, heuristics) that indicates what battery power is needed for the aircraft 900 (given its specifications) to achieve the desired aircraft attitude, speed, etc. The data structure can also take into account the projected payload of the aircraft 900, which can also be indicated in the first flight plan 1310. Thus, for aircraft 900 (e.g., its weight, shape, size, projected payload), the computing system 1100 can determine what power would need to be drawn to maintain the desired operating conditions associated with the first flight plan 1305. By way of example, the computing system 100 can determine what power would need to be drawn from the aircraft's batteries to maintain the first flight plan's desired attitude and speed along a prescribed route to avoid interference and arrive on-time. This computation can be repeated at each of the plurality of times for the first flight plan 1305.

The first expected power demand 1310 can be stored in a first power profile. The first power profile can be a graph, table, or other data structure showing expected power demand values and times along the first flight. The predicted power demand values can be expressed in numerical value, percentage, relative level, etc. The computing system 1100 can store data indicative of the first power profile in an accessible database.

At (1215), the computing system 1100 can access data indicative of an initial battery state 1315 of the energy storage system of the aircraft 900. The data indicative of the initial battery state 1315 can be determined from data collected by an onboard system of the aircraft 900. The onboard system can include a battery management/monitoring system that collects battery state data 1115. The battery state data 1115 can indicate the state of health, state of charge, temperature, etc. The battery data can be provided to the computing system 1100 and stored in a data structure (e.g., look-up table) in a database. The data indicative of the initial battery state 1315 for an aircraft 900 can be stored in a repository of battery state data 1115 for a plurality of aircraft. The computing system 110 can access the data by querying, requesting, pulling, etc. the data from the associated database.

The initial battery state 1315 can be indicative of the actual (or predicted) initial state of an energy storage system of the aircraft 900 prior to the first flight. In some implementations, this can include an initial state of the energy storage system at the beginning of an operational time period for a transportation service (e.g., at the beginning of a day). The initial battery state 1315 can be indicative of, for example, an initial battery temperature, initial battery capacity, initial level of charge, initial battery voltage, etc. of an energy storage system.

The computing system 1100 can determine whether the aircraft 900 is capable of completing the first flight given the initial battery state 1315 of the aircraft 900 and the expected power demand 1310 on its energy storage system. To do so, at (1220), the computing system 1100 can access the battery model 1120.

The battery model 1120 can include a multi-dimensional model configured to determine a predicted battery state at a future time based on the initial battery state 1315 and the expected power demand 1310.

The computing system 1100 can compute a first capability output 1320 for the aircraft 900 based on the battery model 1120. For instance, based on the expected power demand 1310 and the initial battery state 1315 associated with the first flight, the battery model 1120 can be configured to compute the first capability output 1320.

Given the specific aircraft 900 and the initial battery state 1310, the battery model 1120 can step through the expected power demand 1310 throughout the first flight plan (e.g., a mission profile associated therewith) to determine battery states at various times, locations, etc. of the first flight. For example, if the aircraft 900 is flying at a steady airspeed with no change in altitude at time t(n), consuming W(n) kW of power at a temperature of X(n) deg. C., with a remaining battery capacity of Y(n) % (or kWh), and a battery voltage of Z(n) volts, the battery model 1120 can determine that at time t(n+1) the one or more batteries will have a predicted battery state including a temperature of X(n+1) deg. C., a remaining battery capacity of Y(n+1) % (or kWh), and a battery voltage of Z(n+1) volts. The predicted battery state and any updated power demand value at time t(n+1) can then be provided to the battery model 1120 to determine an updated battery state at time t(n+2).

Based on this computation, the computing system 1110 (using the battery model 1120) can compute a range or an available time of flight for the aircraft 900 at various times along the first flight, including the end of the first flight and output the results. The first capability output 1310 can include a computed range or available time of flight for the aircraft 900 for the first flight (e.g., in a table, list, graph, map). This can be a range or available time of flight if the aircraft 900 follows the intended flight plan, given the expected power demand 1310 and the initial battery state 1315. In this way, the battery model 1120 can allow the computing system 1100 to compute an estimate of how long the energy storage system of the aircraft 900 can be used for the first flight, under the current or predicted conditions.

At (1225), the computing system 1100 can determine whether the aircraft 900 is able to perform the first flight based on the first capability output 1320. For instance, the first capability output 1320 can be indicative of a range or an available time of flight for the aircraft 900 at various times along the first flight, including the end of the first flight. The computing system 1100 can access data indicative of the target ranges/available times of flight needed at various points along the first flight. The target ranges/available times can indicate the minimum threshold range/time needed for an aircraft at an associated point or time in the flight. Such information can be stored in a look-up table and associated with a particular flight plan via database referencing, linking, etc. The computing system 1100 can query, search, pull, request, etc. the data indicative the relevant targets from a database in which the look-up table is stored.

The computing system 1100 can compare the ranges/available times of the flight indicated in the first capability output 1320 to the target ranges/available times of flight needed at the various points along the first flight. For example, at a first time (t1) or point (p1) along the first flight, target ranges/available times can indicate the minimum threshold range needed is “Flight 1-Target Range 1” or the minimum remaining time of flight needed for an aircraft is “Flight 1-Target TOF 1”. The first capability output 1320 can indicate that at a first time (t1) or point (p1), the aircraft 900 would have a range of “Flight 1-Predicted Range 1” or an available time of flight of “Flight 1-Predicted TOF 1”. If “Flight 1-Predicted Range 1” is greater than “Flight 1-Target Range 1” and/or “Flight 1-Predicted TOF 1” is greater than “Flight 1-Target TOF 1”, the computing system 1100 can determine that the aircraft 900 can perform the corresponding portion of the first flight plan 1305. Additionally, or alternatively, the computing system 1100 can analyze other battery state information (e.g., temperature, discharge rate) along the first flight.

The computing system 1100 can continue this analysis at various points/times (taking into account the non-linear discharge capacity, rate, time, etc. of the batteries) to determine whether, given the predicted battery states along the first flight, the aircraft 900 is able to traverse the flight path, perform the maneuvers, etc. under the first flight plan 1305.

Based on this comparison, the computing system 1100 can determine the ability of the aircraft 900 to perform the flight. For example, if the ranges/available times of flight indicated in the first capability output 1320 meets or exceeds the threshold ranges/available times specified along the first flight (e.g., at all or an acceptable number of times/points along the second path), the computing system 1100 can determine that the aircraft 900 is able to perform the first flight. This includes the capability to complete the take-off, cruising, landing, and other maneuvers for the first flight, with the appropriate battery temperature ranges, etc.

If, however, the range/available time of flight indicated in the first capability output 1320 does not meet or exceed the threshold ranges/available times, the computing system 1100 can determine that the aircraft 900 is not able to perform the first flight.

At (1230), the computing system 1100 can compute an itinerary 1125 for the aircraft 900 based on the ability of the aircraft 900 to complete a respective flight. For instance, if the aircraft 900 is able to perform the first flight, the computing system 1100 can add the flight plan data 1105 for the first flight to the itinerary 1125 of the aircraft 900. The computing system 1100 can, for example, add an entry for the first flight in a data structure (e.g., schedule, queue, data fields thereof). The computing system 1100 can include, or otherwise link, the flight plan data 1105 associated with the first flight plan 1305 to the entry. If, however, the aircraft 900 is not able to perform the first flight, the computing system 1100 can omit the flight plan data 1105 associated with the first flight from the itinerary 1125 of the aircraft 900.

The computing system can continue to iteratively analyze candidate flights for inclusion in the itinerary 1125 of the aircraft 900 using the battery model 1120. For example, if the computing system 1100 determines that the aircraft 900 is not able to perform the first flight, the computing system 1100 can access flight plan data 1105 indicative of a next flight, to find an initial flight for the aircraft 900, at (1232). The computing system 1100 can repeat operations 1210-1230 for the next flight plan data.

In some implementations, if the computing system 1100 determines that the aircraft 900 is able to perform the first flight (and adds it to the aircraft's itinerary), the computing system 1100 can evaluate additional flights for including in the itinerary 1125 of the aircraft 900.

For instance, at (1235), the computing system 1100 can access flight plan data 1105 associated with a second flight. The second flight can be a candidate flight that, for example, begins after the completion of the first flight. The flight plan data 1105 associated with the second flight plan 1325 can be indicative of a second flight plan 1325. The second flight plan 1325 can be defined by one or more data structures (e.g., table, list). The corresponding flight plan data 1105 associated with second flight can be accessible by the computing system 1100 (e.g., via a database query).

The computing system 1100 can determine a second expected power demand 1330 on the aircraft's energy storage system for the second flight based on the second flight plan 1325. By way of the example, the second expected power demand 1330 can indicate the power draw from the aircraft's battery to perform the flight maneuvers indicated in the second flight plan 1325. The power draw can be estimated for various times/maneuvers throughout the second flight. The second expected power demand 1330 can be computed in a manner similar to that as described herein with respect to the first flight plan 1305. The second expected power demand 1330 can be stored in a second power profile.

Since, in this example, the second flight would occur after the first flight, the computing system 1100 can predict what the future battery state 1335 of the aircraft 900 would be after the aircraft completes the first flight, at (1240).

In some implementations, the predicted future battery state 1335 may have been determined by the battery model 1120 when analyzing the first flight. For example, in computing the first capability output 1320, the battery model 1120 can predict the future battery state 1335 of the aircraft 900 upon completion of the first flight. This future battery state 1335 can be used by the computing system 1100 to determine whether the aircraft 900 would need to be charged/conditioned prior to performing the second flight. Stated differently, the future battery state 1335 (after the first flight) can be considered the initial battery state of the aircraft's energy storage system for the second flight.

Using the battery model 1120, the computing system 1100 can compute a second capability output 1340 based on the second expected power demand 1330 for the second flight and the predicted future battery state 1335. For instance, given the specific aircraft 900 and the future battery state 1335, the battery model 1120 can step through the second expected power demand 1330 throughout the second flight plan 1325 to determine battery states at various times, locations, etc. of the second flight.

By way of example, if the aircraft 900 is flying at a steady airspeed with no change in altitude at time t(m), consuming W(m) kW of power at a temperature of X(m) deg. C., with a remaining battery capacity of Y(m) % (or kWh), and a battery voltage of Z(m) volts, the battery model 1120 can determine that at time t(m+1) the one or more batteries will have a predicted battery state including a temperature of X(m+1) deg. C., a remaining battery capacity of Y(m+1) % (or kWh), and a battery voltage of Z(m+1) volts. The predicted battery state and any updated power demand value at time t(m+1) can then be provided to the battery model 1120 to determine an updated battery state at time t(m+2).

Based on this computation, the computing system 1110 (using the battery model 1120) can compute a range or an available time of flight for the aircraft 900 at various times along the second flight, including the end of the second flight and output the results. The second capability output 1320 can be indicative of these ranges/available times of flight for the aircraft 900 at the plurality of times along the second flight (e.g., in a table, list, graph, map).

At (1245), the computing system 1100 can use the second capability output 1340 to help determine whether the aircraft 900 is able to perform the second flight. For instance, the computing system 1100 can access data indicative of the target ranges/available times of flight needed at various points along the second flight. The target ranges/available times can indicate the minimum threshold range/time needed for an aircraft 900 at an associated point or time in the second flight. Such information can be stored in a look-up table and associated with the second flight plan 1325 via database referencing, linking, etc. The computing system 1100 can query, search, pull, request, etc. the data indicating the relevant targets from a database in which the look-up table is stored.

The computing system 1100 can compare the ranges/available times of the flight indicated in the second capability output 1340 to the target ranges/available times of flight needed at the various points along the first flight. For example, at a first time (t1) or point (p1) along the second flight, target ranges/available times can indicate the minimum threshold range needed is “Flight 2-Target Range 1” or the minimum remaining time of flight needed for an aircraft is “Flight 2-Target TOF 1”. The second capability output 1340 can indicate that at a first time (t1) or point (p1), the aircraft 900 would have a range of “Flight 2-Predicted Range 1” or an available time of flight of “Flight 2-Predicted TOF 1”. If “Flight 2-Predicted Range 1” is greater than “Flight 2-Target Range 1” and/or “Flight 2-Predicted TOF 1” is greater than “Flight 2-Target TOF 1”, the computing system 1100 can determine that the aircraft 900 can perform the corresponding portion of the second flight plan 1325.

The computing system 1100 can continue this analysis (taking into account the non-linear discharge nature of the batteries) at various points/times to determine whether the aircraft 900 is able to traverse the flight path, perform the maneuvers, etc. under the second flight plan 1325. The computing system 1100 can determine the aircraft is able to perform the second flight (without further electric charging/conditioning) if the range/available time of flight (or other battery conditions) for the aircraft 900 indicated in the second capability output 1340 exceeds those thresholds needed for the second flight (e.g., at all or an acceptable number of times/points along the second path).

In some implementations, the computing system 1100 can determine that an aircraft is able to perform a flight if the aircraft is able to complete all the maneuvers, etc. of the flight plan and maintain a buffer energy.

The computing system 1100 can compute how much buffer energy the energy storage system of the aircraft 900 has until downstream operations are impacted. For instance, a buffer energy can be an amount of energy an aircraft is to hold in reserve to allow for variance or unexpected occurrences during the operations of a transportation service (e.g., a multi-modal transportation service). For example, the computing system 1100 can determine that the aircraft 900 is able to perform the second flight, if the aircraft 900 is able to complete all the maneuvers, etc. of the second flight plan (e.g., based on the comparison analysis above) and maintain a buffer energy to avoid impacting downstream operations of the transportation service (e.g., charging flight assignments, delaying another transportation leg, causing adjustments to a matching data structure).

In some implementations, the buffer energy can be computed to provide the aircraft 900 with sufficient charge to perform contingency actions while in-flight. For example, the flight plan can indicate the route (and waypoints thereof) that the aircraft 900 is to follow when travelling from an origin vertiport to a destination vertiport. The computing system 1100 can access data indicative of the closest alternative landing area to each way point along the route. This information can be encoded in map data of the relevant geographic area. The map data can indicate the various possible landing areas for the aircraft 900. This may include vertiports (other than the destination vertiport) or other areas that are available to the aircraft 900 for landing (e.g., leased open space on the top of a building for contingency landings). The computing system 1100 can access the map data by querying a map database using geo-identifiers associated with the route, waypoints of the route, or the relevant geographic area.

At each waypoint along the route, the computing system 1100 can determine the closest landing area for the aircraft 900. The computing system 1100 can compute the distance between the respective waypoint and the closest landing area.

The buffer energy can be computed to provide the aircraft 900 with enough energy to arrive at each of these landing areas, should a contingency be activated. The computing system 1100 can determine the charge level the aircraft 900 will need to arrive at the closest landing area for each waypoint, using the battery model 1120.

To do so, the computing system 1100 can process the map data to determine a distance between the waypoint and the alternative landing area. Moreover, the computing system 1100 may access the flight plan data 1105 to determine the environment conditions in the area. The battery model 1120 can be used to determine the expected power draw on the energy storage systems should the aircraft 900 travel from the respective waypoint, to the alternative landing area under the predicted conditions. Such computation can also take into account the predicted SoC of the energy storage system at that waypoint and consider the non-linear nature of the batteries should the aircraft 900 need to fly to the alternative landing area. In this way, the computing system 1100 can determine the charge level needed for the aircraft 900 to reach, and land at, the alternative landing area.

The computing system 1100 can utilize these respective charge levels to compute the buffer energy for the aircraft 900, so that the aircraft 900 will have enough charge at each respective waypoint to reach the closest landing area, from the respective way point.

In some implementations, the contingencies may include alternative procedures/maneuvers than those included in the flight plan. For example, the contingencies may include a performing a roll landing instead of a vertical landing. In another example, the contingencies may include providing additional charge to operate rotors in a manner to compensate for other rotors.

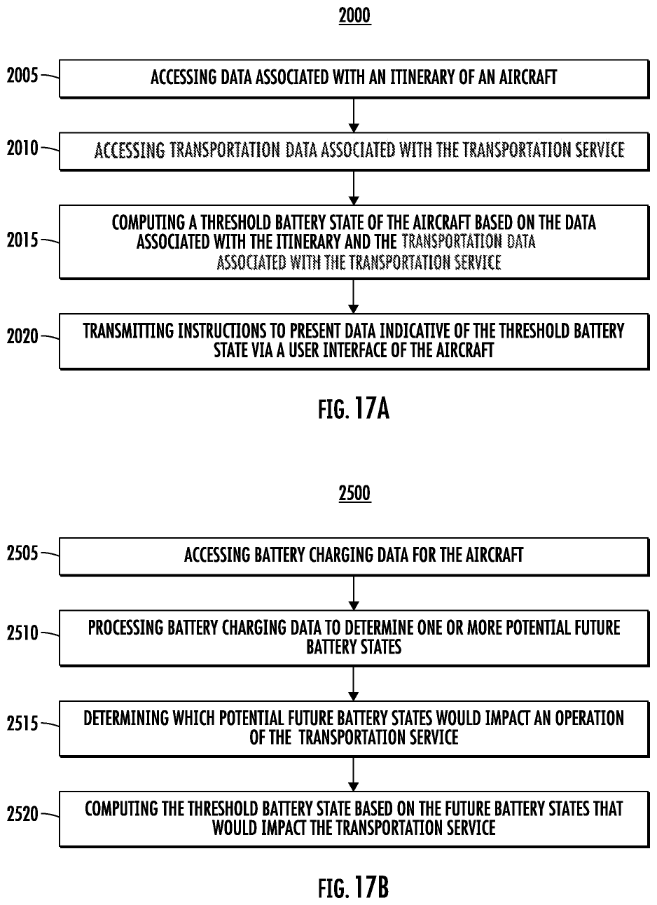

The buffer energy can be a static/set amount (e.g., for low traffic, lower demand, fair-weather regions) or a dynamic/adjustable amount (e.g., for high traffic, higher demand, weather-variable regions). The buffer energy can be computed to take into account the nonlinear charging rates of an aircraft's energy storage system. For example, aircraft batteries can initially charge at a faster rate, but as the batteries are further charged, the rate can slow. The buffer energy can be expressed in terms of battery capacity (e.g., watt-hours (Wh), kilowatt-hours (kWh), ampere-hours (Ahr)), flight range, available flight time, or other measures. The buffer energy can be a certain level above a minimum threshold needed to arrive at a closest, alternative landing area and/or avoid impacting downstream operations of the transportation service, as further described with respect to FIGS. 12 and 17A-B.

If the computing system 1100 determines the aircraft 900 is able to complete the second flight, at (1250), the computing system 1100 can update the itinerary 1125 of the aircraft 900 to include the flight plan data 1105 associated with the second flight. For example, the computing system 1100 can, for example, add an entry for the second flight in the data structure (e.g., queue, schedule) of the itinerary 1125 of the aircraft 900. The computing system 1100 can include, or otherwise link, the flight plan data 1105 associated with the second flight plan 1325 to the entry.

If the computing system 1100 determines that the aircraft 900 may not be able to perform the second flight without further electric charging, the computing system 1100 can evaluate whether the aircraft 900 can be charged between flights so that it would be able to perform the second flight.

For example, at (1255), based on the second capability output, the computing system can determine charging parameters 1130 for charging the energy storage system of the aircraft 900 between the first flight and the second flight. The charging parameters 1130 can indicate a target level of charge, a target temperature, or charging infrastructure. In some implementations, the target level of charge may be output from the battery model 1120.

In some implementations, charging parameters can represent a predicted time, type of equipment, type of charge, and/or other characteristics for charging batteries onboard the aircraft 900 to achieve a particular state of charge. For example, the computing system 1100 can access a data indicating the charging infrastructure at the vertiport at which the aircraft 900 will be located, after the first flight. Such information can be stored in an accessible database associated with the particular vertiport. The computing system 1100 can determine whether the charging infrastructure at the vertiport is able to deliver the charge parameters necessary to charge the aircraft 900 for the second flight. This can include determining whether the chargers and battery thermal management systems (e.g., battery coolers) can charge the batteries to the requisite charge level and reach the appropriate temperature so that it can perform the second flight.

The charging parameters 1130 can allow the computing system 1100 to help determine the additional level of charge, temperature conditioning, etc. needed by the aircraft to perform the second flight, given the predicted future battery state 1335 of the aircraft 900 after the first flight.

To help compute the charging parameters 1130, the computing system 1100 can access battery charging data 1160 (shown in FIG. 8) for the aircraft 900. The battery charging data 1160 can indicate charging specifications for the energy storage system of the aircraft 900. Moreover, the battery charging data 1160 can indicate a correspondence between battery states and charging parameters 1130. For example, the computing system 1100 can access one or more look-up tables or graphs that indicate the charging times, rates, conditions, etc. for charging the aircraft 600 from a first battery state to second battery state.

In some implementations, tables/graphs can be associated with different charging infrastructure. This can allow the computing system 1100 to determine charging parameters based on the various types of available chargers at a particular aerial facility.

The computing system 1100 can determine the charging parameters 1100 for the aircraft 900 based on the predicted future battery state and the battery charging data 1160. For instance, the computing system 1100 can use the look-up tables/graphs to determine how long, at what rates, with what infrastructure, etc. it would take to charge the aircraft 900 from the predicted future battery state to the battery state needed for the second flight. The charging parameters can take into account nonlinear charging rates (e.g., faster charging initially but rate slows as the battery is further charged)

The computing system 1100 can determine whether to include the second flight in the itinerary 1125 for the aircraft 900 based on the charging parameters 1130. For instance, at (1260), the computing system 1100 can access transportation data that is indicative of various types of information associated with a transportation service. For example, as described herein, the transportation data can be indicative of the available charging infrastructure at an aerial facility where the aircraft 900 will land for the first flight. Additionally, or alternatively, the transportation data can be indicative of the itineraries of other aircraft that may be located at or nearby the aerial facility. The transportation data can be indicative of user itineraries 1140 that describe the multiple transportation legs of the users of the transportation service.

The computing system 1100 can utilize the transportation data to help determine whether it would be possible to implement the charging parameters 1130 for the aircraft 900 to be able to perform the second flight. For instance, the transportation data can allow the computing system 1100 to access (or otherwise compute) the timing constraints and infrastructure constraints associated with charging the aircraft 900. By way of example, the computing system 1100 can perform this computation by analyzing the itineraries of the other aircraft (or users) to determine what charging infrastructure is available and how long. Based on the arrival aerial facility (after the first flight) as well as the timing of other flights, aircraft charging, and user transport, the computing system 1100 can use this data to determine whether the appropriate type of charging infrastructure would be available to charge and condition the aircraft's batteries at the necessary rate and time after the first flight, so that the aircraft 900 can perform the second flight.

In some implementations, the computing system 1100 can determine if it is possible to adjust an itinerary of another aircraft to achieve the charging parameters 1130 for the aircraft 900. By way of example, another aircraft may be assigned to certain charging infrastructure (e.g., a higher-speed charging dock). The computing system 1100 can analyze the itinerary of the other aircraft to determine if that other aircraft can depart earlier from the aerial facility (or arrive later to the aerial facility) such that the certain charging infrastructure may be available to the aircraft prior to the second flight.

At (1265), in the event that the computing system 1100 determines that the aircraft 900 can be charged in accordance with the charging parameters 1130 in time to perform the second flight, the flight plan data 1105 associated with the second flight can be added to the itinerary 1125 of the aircraft 900, in a manner similarly described herein.

In the event that the computing system 1100 determines that the aircraft 900 cannot be charged in accordance with the charging parameters 1130 in time to perform the second flight, the second flight can be omitted from the itinerary 1125 of the aircraft 900. In such a case, at (1267), the computing system 1100 can access flight plan data 1105 for another flight and utilize the battery model 1130 to iteratively analyze and stitch together flights (e.g., a third flight, a fourth flight, and so on), until the itinerary 1125 of the aircraft 900 is fully generated, at (1270).

The computing system 1100 can provide instructions 1145 (shown in FIG. 9) associated with implementing the itinerary 1125 for the aircraft 900. For instance, the computing system 1100 can provide instructions 1145 associated with the itinerary 1125 to an aircraft device 435 (e.g., onboard computer, navigation system, flight management system, user device of an operator, etc.), a third party provider system 415 (e.g., of a third party providing the aircraft for the transportation service), an airspace system 420 (e.g., of a regulatory body), an aerial facility device 440, facility operator user device 445, etc. The instructions 1145 can include, for example, data indicative of the computed itinerary 1125 of the aircraft 900. This can include flights, flight plans, associated aerial facilities, downtimes, charging parameters, payload information, etc.

In some implementations, the instructions 1145 can be associated with an adjustment to a transportation service. For example, as described herein, the computing system 1100 can provide instructions 1145 for adjusting the itinerary of another vehicle in order to accommodate charging parameters needed for the aircraft 900 to perform the series of flights included in the aircraft's itinerary. This adjustment can include, for example, re-assigning another aircraft to different charging infrastructure at an aerial facility, adjusting a take-off or landing time of another aircraft, adjusting a take-off or landing maneuver, etc.

Additionally, or alternatively, the computing system 1100 can provide instructions 1145 for adjusting one or more user itineraries 1150. This adjustment can include, for example, re-assigning one or more users (passengers) to different flights/aircraft so that the aircraft 900 has sufficient time to charge. In some implementations, the adjustment can include changing a matching data structure 1155 (e.g., a queue) to adjust a user's priority in a matching with a ground-vehicle (e.g., to reduce potential wait time for a last-leg vehicle). Users can be re-assigned in a manner that does not impact their ultimate ETAs, so that the users still arrive at their ultimate destinations within the preferred timeframe.

According to the present disclosure, the battery modeling technology can also, or alternatively, be used to make dynamic adjustments to aircraft itineraries, or other aspects of a transportation service, in real-time.

For instance, FIG. 11 provides a diagram 1400 of the aircraft 900 travelling along a flight path 1405 (e.g., route associated with a flight plan) to perform a current flight included in its itinerary 1125 and a data flow diagram for making real-time adjustments to a transportation service (e.g., a multi-modal transportation service). The current flight can be included in the itinerary 1125 of the aircraft 900. For example, the current flight can be an intermediate transportation leg for one or more users of a multi-modal transportation service.

During the current flight, there may be a change in circumstances that cause the aircraft to adjust its flight path 1405, aircraft maneuvers, or other aspects of the flight plan. The change in circumstances can include a change in environmental conditions, air traffic, etc. The computing system 1100 can utilize the battery modelling technology of the present disclosure to determine whether it would be appropriate or advantageous to adjust the transportation service in response.

To help do so, the computing system can access data associated with the flight plan 1410 of the flight currently being performed by the aircraft 900. The flight plan 1410 can include one or more data structures (e.g., tables, lists, trees) that store various parameters associated with performing the current flight. As described herein, the parameters stored within the data structure can include a route, vehicle maneuvers, altitudes, environmental conditions, noise constraints, speeds, locations/waypoints, etc. for the current flight.

The computing system 1100 can compute an updated power demand 1415 on an energy storage system of the aircraft 900 based on the data indicative of the current flight plan 1410. This can include an updated power demand 1415 that is based on the change in circumstances. The updated power demand 1415 can be different than the expected power demands determined during itinerary generation. By way of example, the updated power demand 1415 can account for a change in environment conditions or a new aircraft maneuver to be performed by the aircraft 900 in light of the change in such environmental conditions, air traffic, etc. The updated power demand 1415 can be calculated in a manner similar to the expected power demands described herein.

The computing system 1100 can predict a future battery state of the aircraft 900 as well as a course of action for accommodating any real-time changes. For instance, the computing system 1100 can access data indicative of a current battery state 1420 of the aircraft's energy storage system. The current battery state 1420 can be indicative of the current, real-time state of the energy storage system, for example, while the aircraft 900 is in-flight. The current battery state 1420 can be monitored by a battery health system onboard the aircraft 900 and communicated to the computing system 1100 offboard the aircraft 900.

The computing system 1100 can use the battery model 1120 to predict a future battery state 1425 of the aircraft 900 based on the updated power demand 1415 on the aircraft 900 and the current battery state 1420. This can include the future battery state at a destination aerial facility after the current flight. For example, the battery model 1120 can process the updated power demand 1415 and the current battery state 1420 to compute a capability output indicative of an updated range/available time of flight for the aircraft 900 after completion of the current flight, as well as other information about the future state of the battery (e.g., level of charge, temperature, etc.). This updated capability output can be computed in a manner similar to those described herein with reference to FIGS. 9 and 10.

Based on the predicted future battery state 1425 of the aircraft 900, the computing system 1100 can determine an action associated with the transportation service. For instance, the computing system 1100 can access transportation data 1430. As described herein, this data can include the itinerary 1125 of the aircraft 900 or one or more other aircraft, data associated with ground vehicles (e.g., requested to transport a user after a flight), data associated with charging infrastructure at an aerial facility (e.g., types of charging infrastructure, which infrastructure is available, reserved, etc.), data indicative of user itineraries 1140, or other information associated with a multi-modal transportation service.

The computing system 1100 can determine an action 1435 associated with the multi-modal transportation service based on the future battery state 1425 of the aircraft 900 and the transportation data 1430. For example, as further illustrated in the examples below, the computing system 1100 can adjust the operations of a transportation service to accommodate a stop that did not originally have a planned recharge, but now needs a recharge given the predicted future battery state 1425.

The computing system 1100 can transmit (e.g., over a network) instructions 1440 associated with that action 1435 to one or more computing devices. The computing devices 1445 can include one or more of the various computing devices associated with a multi-modal transportation service, as shown for example in FIG. 4A.

The following provides some examples actions 1435 and instructions the computing system 1100 can determine based on the new, predicted future battery state 1425 of the aircraft 900.

In some implementations, the action 1435 can include an adjustment to a flight plan of the aircraft 900 such as, for example, the current flight plan 1410 of the aircraft 900. For instance, given the change in circumstances, the computing system 1100 can determine that the aircraft 900 may arrive at its destination earlier or later than expected (e.g., due to a change in tailwind speed). Based on the future battery state 1425 of the aircraft 900, the computing system 1100 can determine that the aircraft 900 (which may be arriving early) has sufficient range/available time of flight to hover at the aerial facility to allow other incoming aircraft to land (e.g., without negatively impacting the users onboard the aircraft). Accordingly, the computing system 1100 can transmit instructions to update the current flight plan 1410 of the aircraft 900 to include the hover maneuver. Such instructions can cause a change to a data structure associated with the current flight plan 1410 to replace, remove, or append data indicative of a previous maneuver with the newly determined hover maneuver. The updated flight plan can be communicated to the aircraft 900 for implementation by an operator or an onboard autonomous control system.

Additionally, or alternatively, the computing system 1100 can transmit instructions to adjust a current flight plan of another aircraft. For example, the computing system 1100 can transmit instructions to update a data structure associated with the other aircraft's current flight plan to include a hover maneuver. The performance of newly added hover maneuver by the other aircraft can allow the aircraft 900 to land prior to the other aircraft, in the event that the aircraft 900 needs to land earlier to accommodate new or additional charging.

In some implementations, the action 1435 associated with the transportation service can include an adjustment to an itinerary 1125 for the aircraft 900 or one or more other aircraft. For example, the computing system 1100 can determine that based on the future battery state 1425 of the aircraft 900, the aircraft 900 may need additional charging time at a destination aerial facility. Accordingly, the computing system 1100 may transmit instructions 1440 to remove or replace a subsequent flight in the aircraft's itinerary 1125 to provide the aircraft 900 sufficient charging time. The computing system 1100 may also transmit instructions 1440 to adjust the itinerary of another aircraft to include the subsequent flight or to remove a flight that is being re-assigned to the aircraft 900.

Additionally, or alternatively, the computing system 1100 can adjust a payload of an aircraft 900 for a subsequent flight (e.g., re-assign users from that flight) or adjust charging parameters for charging the aircraft 900 after the first flight (e.g., to increase the level of charge). Such adjustments can also be implemented by updating the information stored in the data structure associated with the itinerary 1125 of the aircraft 900 (or another aircraft) or one or more user itineraries 1140.

In some implementations, the computing system 1100 may re-allocate charging infrastructure to the aircraft 900 based on the predicted future battery state 1425. For example, the computing system 1100 can determine that the aircraft 900 should be charged with higher-speed charging infrastructure at an aerial facility. To accommodate, the computing system 1100 can transmit instructions 1440 to adjust the itinerary 1125 of the aircraft 900 (e.g., by updating the data in the stored data structure) to indicate a parking/charging station that includes such infrastructure.

In some implementations, the computing system 1100 can also adjust the itinerary of another aircraft to re-assign the other aircraft to another parking/charging station, so that the desired charging infrastructure is available.

In some implementations, the action 1435 associated with the transportation service can include an adjustment associated with a user of the transportation service. This can include, for example, a user that is currently onboard the aircraft 900 or assigned to a subsequent flight of the aircraft 900. By way of example, in the event that a flight is removed from the itinerary 1125 of the aircraft 900, the user itinerary 1140 of a user assigned to that flight can be updated to reflect another aircraft that will be performing the flight. The user can be a passenger for a multi-modal transportation service, as described herein.

In some implementations, the computing system 1100 can transmit instructions 1440 including a notification to a user device (e.g., a mobile phone of the user) indicating the change in aircraft.

In another example, in the event that the aircraft 900 arrives earlier or later than originally planned, for a multi-modal transportation service, the computing system 1100 can coordinate a subsequent ground transportation leg accordingly. For example, in the event that the aircraft 900 is to arrive later than expected (e.g., at a future aerial facility given the additional charging needed), the computing system 1100 can transmit instructions to adjust a priority associated with a user onboard the aircraft 900, adjust a matching data structure 1155, or take other actions to help ensure that a ground vehicle for transporting the user to the user's final destination is readily available at the aerial facility.

In the event that the aircraft 900 is to arrive earlier than expected, the computing system 1100 can transmit instructions to match the user with a ground vehicle that is available at an earlier time and update the user itinerary 1140 accordingly. This can include transmitting a communication to a GTP system to request that the user be matched with a ground vehicle such that the ground vehicle is available at the destination vertiport for the user upon deboarding the aircraft 900.

In some implementations, the computing system 1100 can transmit instructions (e.g., indicating the delayed user) to a computing device of an operator at the aerial facility to help efficiently transition the user from the aircraft 900 to the ground vehicle.

In some implementations, the computing system 1100 can make an adjustment associated with the pilot operating the aircraft 900. For instance, a change in circumstances associated with the current flight may cause the aircraft 900 to extend its flight time before landing at a destination vertiport. The computing system 1100 can query a database, or call an API of another computing system, to access pilot data using an identifier associated with the pilot. The pilot data may indicate the flight/duty time limit of the pilot as well as the amount of flight time that the pilot has already flown during the current allotment.

The computing system 1100 can determine whether the extension of the current flight will cause the pilot to become unavailable for a subsequent flight. For example, the extension of the current flight may increase the pilot's flight time such that the pilot only has 21 minutes of flight time left on the pilot's allocation (before downtime is required), after the first flight. In the event the subsequent flight includes 25 minutes of flight time, the computing system 1100 may determine that the pilot is not available for the subsequent flight. In response, the computing system 1100 may transmit instructions to assign a new pilot to the aircraft 900 for the subsequent flight. Additionally, or alternatively, the computing system 1100 may reassign the aircraft 900 (and the pilot) to a different subsequent flight that includes substantially less flight time than the pilots remaining allotment.

### Example User Interfaces for Presenting Battery-Based Information

According to the present disclosure, the battery modeling technology can also, or alternatively, be used to improve the operation of the aircraft by an operator (e.g., pilot). This can include, for example, presenting the operator with updated information regarding future battery state and the potential downstream impacts to the overall service.

FIG. 12 depicts a computing device 1500 with a display device 1505 that can be configured to present a user interface 1510 according to example implementations of the present disclosure. The computing device 1500 can be, for example, onboard the aircraft 900 and the display device 1505 can include a screen viewable by an aircraft operator. In some implementations, the computing device 1500 can be offboard the aircraft 900 for a remote operator or support personnel.

The user interface 1510 can present a current power capability display 1515. The current power capability display 1515 can include a column showing values 1520 for current power and a column showing values 1525 for the corresponding remaining time display 1530 in the current flight mode (vertical flight or forward flight). Each of the values 1525 shown in the remaining time display 1530 can correspond to the adjacent value in the current power display 1535. Accordingly, the current power capability display 1515 can indicate what the aircraft 900 is capable of for any of the power levels, irrespective of the actual power level. For example, if the power draw was to be 500 kW then it can be seen that there would be just under ten minutes of available flight time, while at approximately 650 kW there would be approximately 2 minutes of available flight time.

The current (actual) power draw can be indicated on the current power capability display 1515 by means of a current power draw pointer 1540. This pointer can move up and down on the current power capability display 1515 as the power varies throughout a flight. The current power draw pointer 1540 can indicate both the current power draw and the corresponding number of minutes of available flight time remaining and corresponds to the numerical values 1545.

In some implementations, the current power capability display 1515 can include a BE power draw pointer 1550, which marks the best endurance power level and corresponding remaining minutes. This can include a numerical value corresponding to the BE remaining number of minutes.

The user interface 1505 can include a current range output 1555. The current range output can indicate the aircrafts' current range in nautical miles and the corresponding number of minutes of flight time. The values in the current range output 1555 can be based on the (remaining) flight plan/profile, while the remaining minutes indicated by the current power draw pointer 1540 can be based on the current power consumption.

The user interface 1505 can include a battery level output 1560 that indicates a current battery level. The available energy in the battery does not normally correspond to an available capability, since the latter depends on a number of factors (including the battery level), such as battery temperature and voltage level. An ambient conditions display 1565 provides current conditions, including density altitude, outside air temperature, an ISA temperature adjustment, etc.

The user interface 1510 can include a hover capability display 1570. The hover capability display 1570 can provides a display of nominal hover time and CLT hover time. Nominal hover time can be based on all systems of the aircraft 900, working nominally, while the CLT hover time can be based on a worst-case battery failure or worst case motor failure that would degrade aircraft performance.

The hover capability display 1570 can include a variety of values/measurements. For example, this can include numerical values for available hover time for nominal and CLT conditions, at the current ambient conditions. The hover capability display 1570 can include a column of hover times. Two nominal and two CLT hover times can be indicated in the column. For example, the two pointers 1575 and 1576 can indicate the available hover times at conditions at the destination, which is where the aircraft 100 is likely to go into a vertical/hover flight mode for landing. These pointers can include a destination conditions pointer 1575 for nominal hover time and a destination conditions pointer 1576 for CLT hover time.

The hover capability display 1570 can also include pointers indicative of available hover times at current conditions. For example, current conditions pointer 1577 can indicate the nominal hover time for the current conditions, while current conditions pointer 1578 can indicate CLT hover time for the current conditions.

The battery technology of the present disclosure can be utilized to facilitate the presentation of threshold battery levels at which downstream operations of a transportation service (e.g., a multi-modal transportation service) may be impacted if the aircraft 900 were to fall below these levels prior to landing.

To help determine the threshold battery levels, the computing system 1100 can access data associated with an itinerary 1125 of the aircraft 900. The itinerary 1125 can indicate one or more charging parameters (e.g., times, target conditions, infrastructure, rate) for charging the aircraft 900 at the destination aerial facility. The itinerary 1125 can also include current and future flight plans/flights assigned to the aircraft 900, arrival/departure aerial facilities, landing/parking/charging locations, arrival/departure times, etc.

The computing system 1100 can access transportation data. As described herein, this data (e.g., multi-modal transportation service data) can indicate flight plans/flights assigned to other aircraft associated with the transportation service, charging parameters associated with other aircraft, arrival/departure aerial facilities of other aircraft, landing/parking/charging locations of other aircraft, arrival/departure times of other aircraft, user itineraries (e.g., including ETAs, locations, assigned flights), etc.

The computing system 1100 can compute a threshold battery state of the aircraft 900 based on the data associated with the itinerary of the aircraft 900 and the transportation data. In an example, the threshold battery state can be indicative of one or more threshold battery levels (e.g., range threshold level, charge threshold level) below which an operation of a multi-modal transportation service is predicted to be impacted. Said differently, if the energy storage system of the aircraft 900 falls below these threshold battery levels before the aircraft 900 lands at the destination, it is predicted that the computing system 1100 would need to make at least one change to the multi-modal transportation service to accommodate additional re-charging of the aircraft 900.

To compute the threshold battery state, the computing system 1100 can predict what future battery state would cause a change to the currently planned charging parameters of the aircraft 900 that would also impact the overall operations of the transportation service.

For instance, the computing system 1120 can iteratively analyze a plurality of potential future battery states to determine what charging parameters would need to be changed to get the aircraft 900 to the appropriate battery conditions to perform a subsequent flight. This can be accomplished by accessing a data structure (e.g., a look-up table) for the specific energy storage system that corresponds initial battery state to various charging parameters (e.g., time, temp., charge rate) and to different resultant battery levels. Such information can be stored, for example, in the battery charging data 1160 (shown in FIG. 8). The charging parameters can take into account nonlinear charging rates (e.g., faster charging initially but rate slows as the battery is further charged). This can be helpful because not all excess energy use will impact downstream charging times the same.

For each potential future battery state, the computing system 1120 can determine if there would be a corresponding change in charging parameters from the currently planned charging parameters. For example, a first potential future battery state where the aircraft 900 has a lower charge level may require additional charge time (e.g., depending on the speed of charge, temperature, nonlinear charge rate) or different charging infrastructure (e.g., for a higher speed charger). The computing system 1120 can perform a forward simulation of the multi-modal transportation service (e.g., including the current aircraft/user itineraries) to determine whether the increased charge time or change in charging infrastructure may impact an operation of the multi-modal transportation service. For example, the increased charged time may require one or more users to be re-assigned to another aircraft to avoid delaying the users' arrival at their ultimate destinations. In some implementations, this may be considered an impact on the operation of the multi-modal transportation service. However, in some implementations, this may be acceptable (and not considered an impact) if all users are able to successfully arrive at their ultimate destinations on-time.

In another example, the increased charged time may delay a subsequent flight assigned to the aircraft 900. If the flight cannot be assigned to another aircraft or the users cannot be assigned to another flight (e.g., resulting in an unacceptable delay in the users' ultimate ETA), the first potential future battery can be said to impact an operation of the multi-modal transportation service.

In another example, the change in charging infrastructure (e.g., to a higher speed charger) may allow the aircraft 900 to re-charge in time for its next assigned flight. However, another aircraft may have been re-assigned away from that charging infrastructure and unable to re-charge in time for its next assigned flight, causing a delay. In such a scenario, the first potential future battery state can be identified as impacting an operation of the multi-modal transportation service.

Based on the iterative analysis of potential future battery states and the corresponding forward simulation for operational impacts, the computing system 1120 can select a respective potential future battery state for generating a threshold indicator for the aircraft 900. This can include, for example, the potential future battery state with the highest charge level, highest remaining range/time of flight, etc. that would still result in an impact to the operation of the multi-modal transportation service. This can include the future battery state that is closest to the currently predicted future battery state of the aircraft 900.

The computing system 1100 can utilize the battery model 1120 to determine the threshold battery state to display within the aircraft 900. For example, the computing system 1100 can utilize the battery model 1120 (e.g., as a reverse calculation) to determine a battery state/conditions that results in the potential future battery state, which was identified as impacting the operations of the multi-modal transportation service. The computing system 1100 can determine the threshold battery state based on the determined battery state. For example, using the battery model 1120, the computing system 1100 can determine that the aircraft 900 would achieve the future battery state if the aircraft 900 were to have a range level of “X” NM, time of flight of “Y” minutes, or a charge level of “Z” KWH. These levels can continue to dynamically change over time as the battery and operating conditions of the aircraft 900 change.

The computing system 1100 can transmit (e.g., over a network) instructions to present data indicative of the threshold battery state via the user interface 1510 of a computing device 1500 onboard the aircraft 900. For example, the computing system 1100 can transmit instructions that indicate the computing device 1500 is to display (e.g., via its display device 1505) the determined threshold. The computing device 1500 can process these instructions and provide the threshold battery state for display through the user interface 1510. This can result in the user interface 1510 presenting a range threshold indicator 1580 or a battery level threshold 1585. For example, the indicators 1580 and 1585 can be presented on (or near) the current range output 1555 or battery level output 1560, respectively.

According to the present disclosure, the battery modelling technology can be used to compare battery state predictions versus actual performance to improve aspects of the transportation system. For instance, as described herein, the computing system 1100 can compute a predicted future battery state of the aircraft 900 using the battery model 1120. The predicted future battery state of the aircraft 900 (e.g., the predicted end state after a current flight) can be displayed within the user interface 1510 as an end state indicator 1582. The end state indicator 1582 can indicate the energy level of the batteries predicted to be available after completion of the current flight.

Upon arrival, the computing system 1100 can access data indicative of the actual battery state of the aircraft 900 at the destination aerial facility (e.g., via communication with an onboard computing device).

The computing system 1100 can compare the predicted future battery state and the actual battery state of the aircraft 900 at the destination aerial facility. For instance, the computing system 1100 can compare the predicted range or time of flight to the actual range or time of flight of the aircraft 900 when it gets to the aerial facility. In the event that the predicted range/time of flight is significantly different, the computing system 1100 can reconfigure, retrain, provide feedback, etc. for the battery model 1120 to improve accuracy.

In some implementations, the computing system 1100 can compute an operator efficient rating based on the comparison of the predicted future battery state and the actual battery state of the aircraft 900. The efficiency rating can be expressed as a numerical value (e.g., 1-5 scale), alphabetic expression (e.g., excellent, average, poor), color, etc. For example, the computing system 1100 can compute a higher efficiency rating for an operator (e.g., pilot, remote operator) of the aircraft 900 in the event that the actual battery state is greater (e.g., maintains higher range/ToF) than the predicted battery state. To the extent the operator already has an efficiency rating, the computing system 1100 may increase the rating in such a scenario.

In another example, the computing system 1100 can compute a lower efficiency rating for an operator of the aircraft 900 in the event that the actual battery state is less than (e.g., maintains lower range/ToF) than the predicted battery state. To the extent the operator already has an efficiency rating, the computing system 1100 may decrease the rating in such a scenario.

In some implementations, the user interface 1510 can include a contingency display 1584. The contingency display 1584 can be a UI map interface that includes a route indicator 1586 representing the current route of the aircraft 900. The contingency display 1584 can include one or more waypoint indicators 1588 indicating the waypoints of the route. The contingency display 1584 can include the alternative landing areas 1590 for which the aircraft 900 has sufficient energy to reach, as described herein. The contingency display 1584 can include a progress indicator 1592 indicative of the aircraft's real-time progress along the route.

In some implementations, the respective alternative landing areas 1590 can be displayed as the aircraft 900 progresses along the route. This can include removing alternative landing areas 1590 as the aircraft 900 progresses along the route to display the relevant landing areas 1590 for the current and future waypoints, as computed using the battery model 1120. In some implementations, the contingency display 1584 can indicate the charge level at each waypoint or a predicted charge level at an alternative landing area, if reached. This information may be presented, for example, scrolling over, touching, etc. the waypoint indicators 1588 or the UI elements representing the alternative landing areas 1590.

### Example Computer-Implemented Processes and Methods

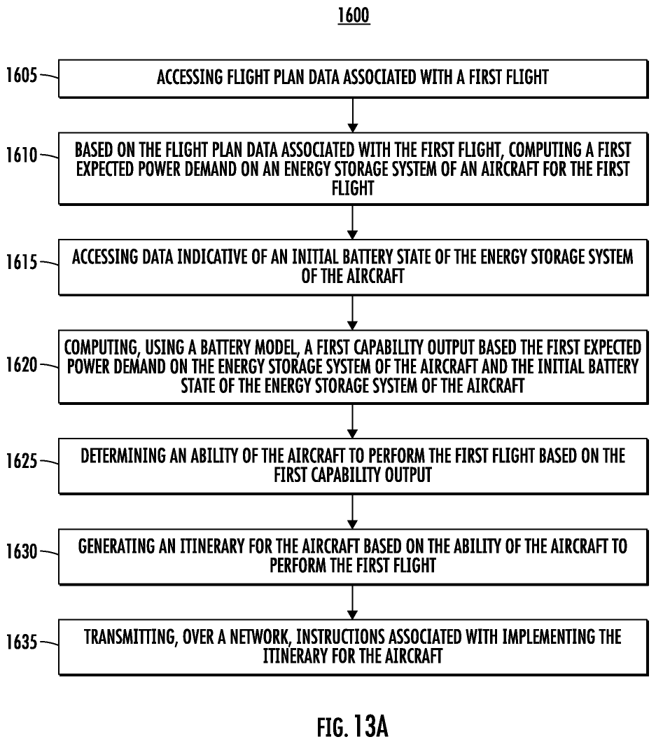

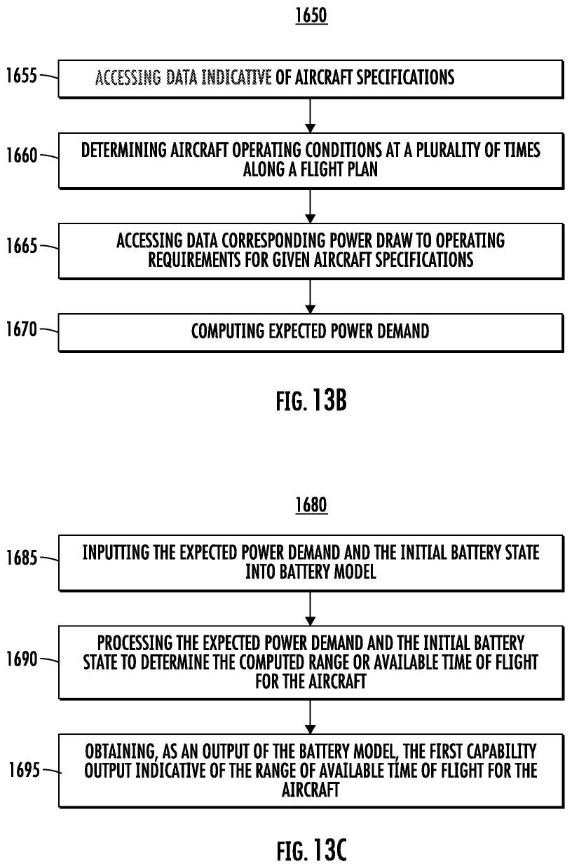

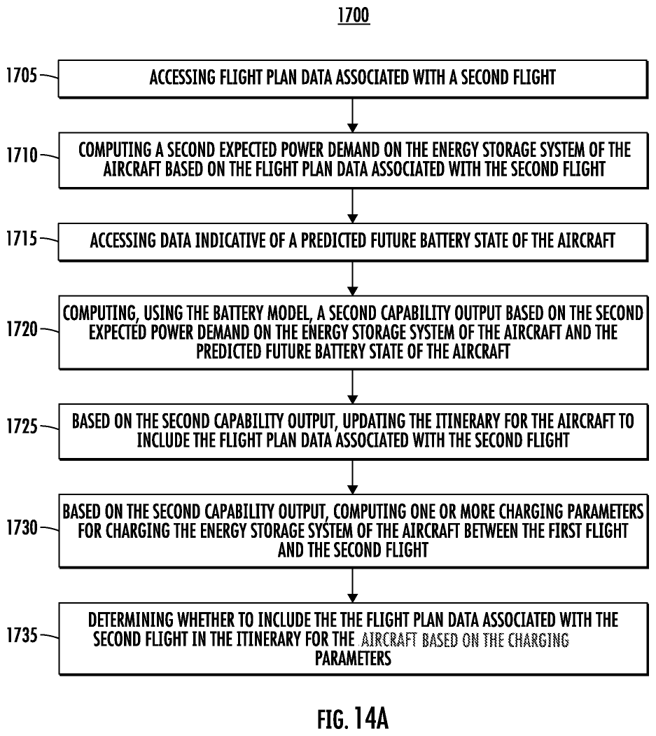

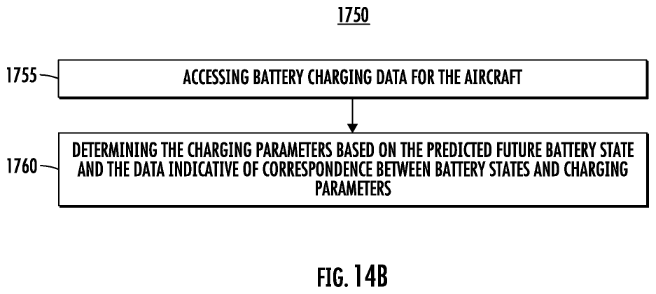

FIGS. 13A-20B are flowchart diagrams of example methods according to example embodiments of the present disclosure. The methods can be performed by a computing system that includes one or more computing devices such as, for example, the computing systems described with reference to the other figures herein. Each respective portion of the methods can be performed by any (or any combination) of one or more computing devices. Moreover, one or more portions of these methods can be implemented as one or more algorithms on the hardware components of the devices described herein (e.g., as in FIGS. 4A-8, 12, 18, etc.), for example, to compute aircraft itineraries, initiate adjustment actions to a transportation service, present information onboard an aircraft, etc.

FIGS. 13A-20B depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

FIGS. 13A-20B are described with reference to elements/terms described with respect to other systems and figures for exemplary illustrated purposes and is not meant to be limiting. One or more portions of the methods can be performed additionally, or alternatively, by other systems.

FIG. 13A is a flowchart diagram of an example computer-implemented method 1600 for generating an itinerary for an aircraft according to example embodiments of the present disclosure.

At (1605), a computing system can access flight plan data associated with a first flight. This can include accessing data associated with a first flight plan of the first flight. As described herein, the first flight can be associated with a transportation service. The transportation service can be or otherwise include a multi-modal transportation service, which can include: (i) a first transportation leg including a first ground transportation service from an origin, (ii) an intermediate transportation leg including the first flight, and (iii) a second ground transportation service to a destination. The data associated with the first flight plan of the first flight can be indicative of at least one of the following for the first flight: (i) a route, (ii) an altitude, (iv) an environmental condition, (v) a noise constraint, or (vi) a speed. The data associated with the first flight plan of the first flight can be indicative of one or more aircraft maneuvers for performing the first flight (e.g., take-off maneuver, landing maneuver, hover maneuver, cruise maneuver).

Based on the flight plan data associated with the first flight (e.g., data associated with the first flight plan), at (1610), the computing system can compute a first expected power demand on an energy storage system of an aircraft for the first flight.

For instance, with reference to method 1650 of FIG. 13B, at (1655), the computing system can access data indicative of aircraft specifications for the aircraft. The aircraft specifications can be stored in an accessible data structure that is indicative of characteristics of the aircraft or its energy storage system. This can include aircraft weight, shape, size, propulsion, payload capacity, battery type, battery configuration, battery capacity, etc. The computing system can query the database to retrieve this information.

At (1660), the computing system can determine one or more aircraft operating conditions at a plurality of times along the flight plan. For example, the computing system can parse the flight plan to determine at each time: the desired aircraft attitude, speed, orientation, location, or other aircraft operating conditions.

At (1665), the computing system can access data corresponding a power draw on the energy storage system of the aircraft to the aircraft operating conditions. For instance, the computing system can access a data structure that indicates what battery power is needed for the particular aircraft, given its specifications, to achieve the desired aircraft attitude, speed, etc. The data structure can be, for example, a graph or look-table that the computing system can access with a look-up function. In some implementations, the data structure can include heuristics that indicate the needed battery power.

The data structure can also take into account the projected payload of the aircraft, which can also be indicated in the proposed flight plan. Thus, for a particular aircraft (e.g., weight, shape, size, projected payload), the computing system can determine what power would need to be drawn to maintain the desired operating conditions associated with the flight plan. For example, the computing system can determine what power would need to be drawn from the aircraft's batteries to maintain the flight plan's desired attitude and speed along a prescribed route to avoid interference and arrive on-time. This computation can be repeated at each of the plurality of times along the flight plan.

Based on this analysis, the computing system can compute the expected power demand on an energy storage system of an aircraft for a flight, at (1670). This can include, for example, a predicted power demand value for one or more batteries of an aircraft based on the parameters of the flight plan and the particular aircraft specifications. The predicted power demand value can include an amount of power predicted to be drawn from the energy storage system. For example, for a flight plan, an expected power demand can be determined from parameters of the aircraft (e.g., weight, rotor configuration, shape), parameters at the origin and destination (e.g., altitude, outside air temperature, hover times, approach maneuvers), in-flight parameters/conditions (e.g., flight maneuvers, intended cruising altitude, cruising speed, wind direction), taxi time, etc.

Returning to FIG. 13A, at (1615), the computing system can access data indicative of an initial battery state of the energy storage system of the aircraft. As described herein, the initial battery state can be the state of the batteries of the aircraft prior to the first flight.

At (1620), the computing system can compute, using a battery model, a first capability output based the first expected power demand on the energy storage system of the aircraft and the initial battery state of the energy storage system of the aircraft. The computing system can compute the first capability output in a manner as previously described herein.

For instance, with reference to method 1680 of FIG. 13C, at (1685), the computing system can input the expected power demand and the initial battery state into the battery model.

At (1690), the computing system can utilize the battery model to process the expected power demand and the initial battery state to determine the computed range or available time of flight for the aircraft. For instance, as previously described herein, the battery model can step through the expected power demand throughout the flight plan to determine battery states at various times, locations, etc. of the flight. By way of example, if the aircraft is flying at a steady airspeed with no change in altitude at time t(n), consuming W(m) kW of power at a temperature of X(n) deg. C., with a remaining battery capacity of Y(n) % (or kWh), and a battery voltage of Z(n) volts, the battery model can determine that at time t(n+1) the one or more batteries will have a predicted battery state including a temperature of X(n+1) deg. C., a remaining battery capacity of Y(n+1) % (or kWh), and a battery voltage of Z(n+1) volts. The predicted battery state and any updated power demand value at time t(n+1) can then be provided to the battery model to determine an updated battery state at time t(n+2).

At (1695), the computing system can obtain, from the battery model, the first capability output. As described herein, the capability output can be indicative of the range or available time of flight for the aircraft at various times.

Returning to FIG. 13A, at (1625), the computing system can determine an ability of the aircraft to perform the first flight based on the first capability output. For example, the computing system can determine whether the aircraft would have sufficient range or available time of flight along the flight path to perform the first flight. In some implementations, as described, this can include having an energy buffer to help avoid impacting downstream operations of the multi-modal transportation service and/or to perform contingencies.

At (1630), the computing system can generate an itinerary for the aircraft based on the ability of the aircraft to perform the first flight. For instance, in the event it is determined that the aircraft is able to perform the first flight, the computing system can generate the itinerary for the aircraft by adding the data associated with the first flight to the itinerary for the aircraft. Adding the first flight to the itinerary can include adding the flight plan data associated with the first flight to one or more data fields of a data structure associated with the itinerary. In the event it is determined that aircraft is not able to perform the first flight, the computing system can omit the data associated with the first flight from the itinerary for the aircraft.

At (1635), the computing system can transmit, over a network, instructions associated with implementing the itinerary for the aircraft. This can include storing the itinerary with an entry for the first flight. Additionally, or alternatively, the computing system can transmit instructions to an aircraft device, aerial facility device, facility operator user device, third party system, etc. to help implement the itinerary for the aircraft, as described herein.

The computing system can continue to iteratively evaluate flights for generating the aircraft's itinerary. For instance, FIG. 14A is a flowchart diagram of an example computer-implemented method 1700 for generating an itinerary for an aircraft based on a second flight according to example embodiments of the present disclosure.

At (1705), the computing system can access flight plan data associated with a second flight. This can include accessing data associated with a second flight plan of the second flight. The second flight can occur after the first flight. The data associated with the second flight plan of the second flight can be indicative of at least one of the following for the second flight: (i) a route, (ii) an altitude, (iv) an environmental condition, (v) a noise constraint, or (vi) a speed. The data associated with the second flight plan of the second flight can be indicative of one or more aircraft maneuvers for performing the second flight (e.g., take-off maneuver, landing maneuver, hover maneuver, cruise maneuver, taxing maneuver). The computing system can query a database to access a data structure (e.g., table, list) that is indicative of the second flight plan.

At (1710), the computing system can compute a second expected power demand on the energy storage system of the aircraft based on the flight plan data associated with the second flight (e.g., the data associated with the second flight plan), in a manner similar to that described with respect to the first expected power demand of FIG. 13B.

At (1715), the computing system can access data indicative of a predicted future battery state of the aircraft. For instance, the computing system can store the first capability output in an accessible database. Recall, the first capability output can indicate future battery states predicted to occur at future times. The computing system can access this information to determine the predicted battery state of the aircraft when evaluating the second flight. For example, the predicted future battery state of the aircraft can be one that is/was computed by the battery model based on the first expected power demand on the energy storage system of the aircraft and the initial battery state of the energy storage system of the aircraft (used for evaluating the first flight).

At (1720), the computing system can compute, using the battery model, a second capability output based on the second expected power demand on the energy storage system of the aircraft and the predicted future battery state of the aircraft. The second capability output can be indicative of a future range or a future available time of flight of the aircraft for the second flight.

The computing system can compute the second capability output in a manner similar to that of the first capability output, as described with reference to FIG. 13C. For instance, the computing system can input the second expected power demand and the predicted future battery state into the battery model. The computing system can utilize the battery model to process the second expected power demand and the predicted future battery state to determine the computed range or available time of flight for the aircraft at various times along the second flight. The computing system can obtain the second capability output from the battery model.

In some implementations, at (1725), based on the second capability output, the computing system can update the itinerary for the aircraft to include the flight plan data associated with the second flight. For example, if the computing system determines the aircraft is able to complete the second flight, the computing system can update the itinerary of the aircraft to include the second flight. Including the second flight can include adding the flight plan data associated with the second flight to one or more data fields of a data structure associated with the itinerary. However, if the computing system determines the aircraft is not able to complete the second flight (even without additional charging or other changes), the computing system can omit the second flight from the itinerary of the aircraft.

In some implementations, if the computing system determines that the aircraft may not be able to perform the second flight without further electric charging, the computing system can evaluate whether the aircraft can be charged between flights so that it would be able to perform the second flight.

For instance, at (1730), based on the second capability output, the computing system can compute one or more charging parameters for charging the energy storage system of the aircraft between the first flight and the second flight. As described herein, the charging parameters can be indicative of at least one of: a target level of charge, a target temperature, or charging infrastructure.

Method 1750 of FIG. 14B provides an example process for computing the charging parameters.

At (1755), the computing system can access battery charging data for the aircraft. The battery charging data can indicate charging specifications for the energy storage system of the aircraft. Moreover, the battery charging data can indicate a correspondence between battery states and charging parameters. For example, the computing system can access one or more look-up tables or graphs that indicate the charging times, rates, conditions, etc. for charging the aircraft from a first battery state to second battery state.

In some implementations, tables/graphs can be associated with different charging infrastructure. This can allow the computing system to determine charging parameters based on the various types of available chargers at a particular aerial facility.

At (1760), the computing system can determine the charging parameters for the aircraft based on the predicted future battery state and the battery charging data. For instance, the computing system can use the look-up tables/graphs to determine how long, at what rates, with what infrastructure, what temperature control, etc. it would take to charge the aircraft from the predicted future battery state to the battery state needed for the second flight.

Returning to FIG. 14A, at (1735), the computing system can determine whether to include the second flight (e.g., the flight plan data associated with second flight) in the itinerary for the aircraft based on the charging parameters. For instance, as described herein, the computing system can determine whether the charging parameters would permit the aircraft to be re-charged in time for the second flight based on the timing and infrastructure constraints of the transportation service.

If so, the computing system can add the second flight to the aircraft's itinerary. This can include adding at least a portion the flight plan data of the second flight to one or more data fields of a data structure defining the aircraft's itinerary.

If not, the computing system can evaluate whether one or more operations of the transportation service (e.g., the multi-modal transportation service) can be adjusted to accommodate the charging parameters. This can include, for example, changing itineraries, charging infrastructure, user itineraries, or other aspects in a manner that would not cause an acceptable delay (e.g., greater than 5 min., 7 min.) to the aircraft or a downstream transportation leg.

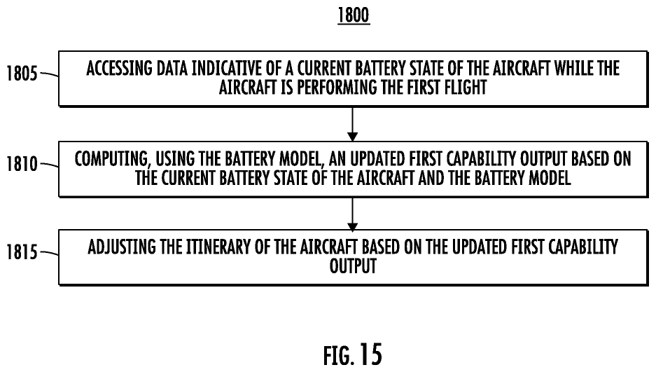

In some implementations, the computing system can use the battery model to make real-time itinerary adjustments for the aircraft. For instance, FIG. 15 is a flowchart diagram of an example computer-implemented method 1800 for updating an itinerary for an aircraft according to example embodiments of the present disclosure.

As described herein, during a flight, there may be a change in circumstances that cause the aircraft to adjust its flight path, aircraft maneuvers, or other aspects of the flight plan.

At (1805), the computing system can access data indicative of a current battery state of the aircraft while the aircraft is performing the first flight. As described herein, the current battery state can be indicative of the current, real-time state of the energy storage system, for example, while the aircraft is in-flight. The current battery state can be captured by a battery monitory system onboard the aircraft and communicated to a computing system offboard the aircraft.

At (1810), the computing system can compute, using the battery model, an updated capability output based on the current battery state of the aircraft and the battery model. For example, the computing system can compute an updated expected power demand on an energy storage system of the aircraft based on the data indicative of the flight plan, given the change in circumstances. By way of example, the updated expected power demand can account for a new aircraft maneuver to be performed by the aircraft in light of the change in environmental conditions, air traffic, etc. In a similar manner to that previously described herein, the computing system can input the current battery state of the in-flight aircraft and the updated expected power demand into the battery model to receive the updated capability output.

In some implementations, a change in a future battery state may not result in downstream changes. For example, the computing system can determine that given the nonlinear charge rate of the aircraft's batteries, the aircraft can still be charged at the destination aerial facility without adjusting the aircraft's itinerary.

In some implementations, the computing system can adjust the itinerary of the aircraft based on the updated capability output at (1815). For example, due to the change in circumstances (e.g., increased headwind) the aircraft may have a lower charge level than expected at the destination aerial facility. To address this, the computing system can adjust the itinerary of the aircraft. Adjusting the itinerary of the aircraft can include, for example, at least one of: (i) adjusting a payload of the aircraft for a subsequent flight, (ii) adjusting one or more charging parameters for charging the aircraft after the first flight, or (iii) removing a subsequent flight from the itinerary of the aircraft. In some implementations, an adjustment can be made to the pilot of the aircraft (e.g., due to increases in flight time incurred by the pilot).

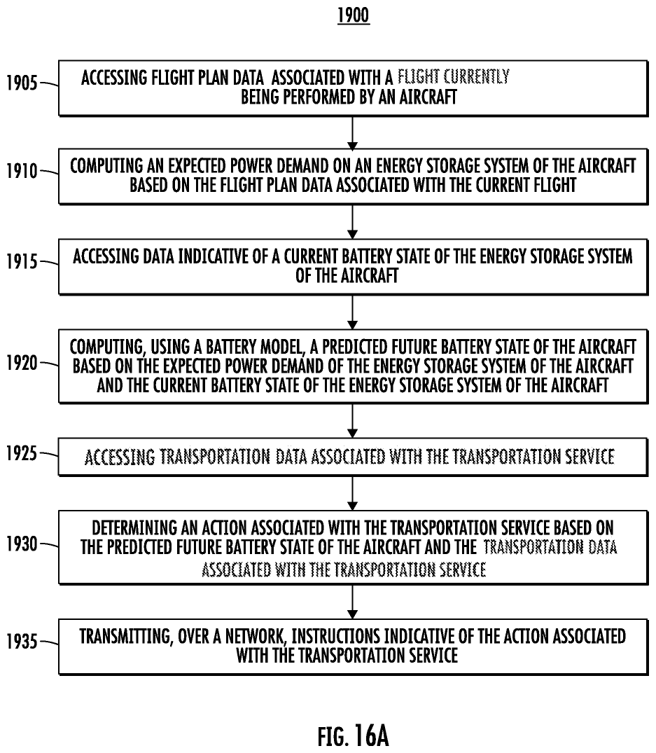

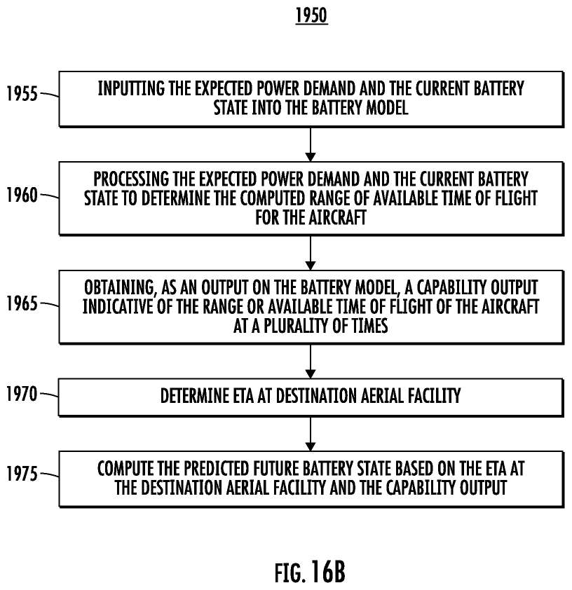

As described herein, the battery modelling technology of the present disclosure can be used to make dynamic, real-time adjustments to the operations of a transportation service. For instance, FIG. 16A is a flowchart diagram of an example computer-implemented method 1900 for adjusting the operations of a transportation service (e.g., multi-modal transportation service) according to example embodiments of the present disclosure.

At (1905), the computing system can access flight plan data associated with a flight currently being performed by an aircraft. This can include accessing data associated with a flight plan of the current flight. The flight can be associated with a multi-modal transportation service. For example, the flight can be an intermediate transportation leg of a multi-leg transportation service.

At (1910), the computing system can compute an expected power demand on an energy storage system of the aircraft based on the flight plan data associated with the current flight, as described herein.

At (1915), the computing system can access data indicative of a current battery state of the energy storage system of the aircraft. For instance, the computing system can obtain data from a battery health monitoring system of the aircraft. The current battery state can indicate the current charge level, temperature, and health of the battery.

At (1920), the computing system can compute, using a battery model, a predicted future battery state of the aircraft based on the expected power demand on the energy storage system of the aircraft and the current battery state of the energy storage system of the aircraft.

Method 1950 of FIG. 19B provides an example process for computing the predicted future battery state of the aircraft.

At (1955), the computing system can input the expected power demand and the current battery state into the battery model. The computing system can access the battery model by querying a local database, calling an API of another computing system, or utilizing the battery model via a micro-service of the computing system. As described herein, the battery model can include a multi-dimensional model configured to determine a predicted battery state at a future time based on the current battery state and the expected power demand.

At (1960), the computing system can process the expected power demand and the current battery state to determine the computing range or available time of flight for the aircraft. For example, given the specific aircraft and the current battery state, the battery model can step through the expected power demand throughout a mission profile associated with a fight to determine battery states at various times, locations, etc. of the flight.

At (1965), the computing system can obtain, as an output of the battery model, a capability output indicative of the range or available time of flight of the aircraft at a plurality of times. As described herein, the capability output can be provided by the battery model.

At (1970), the computing system can determine an estimated time of arrival (ETA) of the aircraft at a destination airport. For instance, the computing system can predict the ETA based on the aircraft's current flying speed, conditions, etc. The computing system can access this information via an avionics system and/or sensors onboard the aircraft.

At (1975), the computing system can compute the predicted future battery state based on the ETA at the destination aerial facility and the capability output. For instance, the computing system can use the ETA to look up the predicted battery range or time of flight in the capability output. This can allow the computing system to determine the predicted future battery state.

Returning to FIG. 16A, to help determine a potential action for adjusting the operations of a transportation service, the computing system can access transportation data associated with the transportation service (e.g., data associated with the multi-modal transportation service), at (1925). As described herein, the data associated with the transportation service (e.g., multi-modal transportation service) can include at least one of: (i) an itinerary of the aircraft, (ii) data associated with one or more other aircraft associated with the transportation service, or (iii) data associated with one or more users of the transportation service.

At (1930), the computing system can determine an action associated with the transportation service (e.g., the multi-modal transportation service) based on the predicted future battery state of the aircraft and the transportation data associated with the transportation service. For example, an action associated with the transportation service can include at least one of: (i) an adjustment to the flight plan, (ii) an adjustment to an itinerary for the aircraft, (iii) an adjustment to an itinerary of another vehicle, (iv) an adjustment to an itinerary of a user, or (v) an adjustment to a ground transportation service.

In some implementations, the computing system can determine one or more charging parameters for the aircraft based on the predicted future battery state of the aircraft and determine an action associated with the multi-modal transportation service based on the one or more charging parameters. For instance, the computing system can determine charging parameters for re-charging the aircraft (after the current flight) using the approaches previously described herein. Based on the charging parameters, the computing system can determine whether the aircraft can be re-charged in time for its next flight or whether action is needed to re-assign certain charging infrastructure (e.g., higher speed chargers), re-assign the flight to another aircraft, re-assign users to another flight, delay take-off, etc.

At (1935), the computing system can transmit, over a network, instructions indicative of the action associated with the transportation service (e.g., the multi-modal transportation service). This can include transmitting instructions to one or more computing devices associated with the multi-modal transportation service. For example, the computing system can transmit instructions to one or more user devices to information a facility operator, aircraft operator, a user, etc., of a change. In another example, the computing system can transmit instructions to update the itinerary stored in an accessible database. In some implementations, the computing system can transmit instructions for charging the aircraft in accordance with the charging parameters.

As described herein, the battery modelling technology of the present disclosure can be used to present information to aircraft operations in real-time. For instance, FIG. 17A is a flowchart diagram of an example computer-implemented method 2000 for generating information regarding potential operational impacts for display onboard an aircraft according to example embodiments of the present disclosure.

At (2005), the computing system can access data associated with an itinerary of an aircraft. As described herein, the itinerary can indicate one or more charging parameters for charging the aircraft at the destination aerial facility, current and future flight plans/flights assigned to the aircraft, arrival/departure aerial facilities, landing/parking/charging locations, arrival/departure times, etc.

At (2010), the computing system can access transportation data associated with a transportation service (e.g., a multi-modal transportation service). As described herein, the data associated with the transportation service (e.g., the multi-modal transportation service) can indicate flight plans/flights assigned to other aircraft associated with the transportation service, charging parameters associated with other aircraft, arrival/departure aerial facilities of other aircraft, landing/parking/charging locations of other aircraft, arrival/departure times of other aircraft, user itineraries, etc.

At (2015), the computing system can compute a threshold battery state of the aircraft based on the data associated with the itinerary and the transportation data associated with the transportation service.

For instance, with reference to method 2500 of FIG. 20B, the computing system can access battery charging data for the aircraft, at (2505). The battery charging data can include a data structure (e.g., a look-up table, graph) that corresponds an initial battery state to different resultant battery states based on various charging parameters (e.g., time, temp., charge rate).

At (2510), the computing system can process the battery charging data to determine one or more potential future battery states. For instance, the computing system can analyze the battery charging data to identify a plurality of potential future battery states that would result in a change in the current charging parameters of the aircraft (e.g., in order for the aircraft to be sufficiently charged for the next flight). For example, if the aircraft would arrive at its destination with a lower charge level it may require additional charging time. Although, this may not always be the case, as the computing system can take into account the non-linear charging rates of the batteries.

At (2515), the computing system can determine which potential future battery states would impact an operation of the transportation service (e.g., multi-modal transportation service). For instance, as described herein, for each respective potential future battery state, the computing system can perform a forward simulation of the multi-modal transportation service (e.g., including the current aircraft/user itineraries) to determine whether the changed charging parameters may impact an operation of the multi-modal transportation service (e.g., flight delay, rider re-assignment).

At (2520), the computing system can compute the threshold battery state based on the future battery states that would impact the transportation service (e.g., multi-modal transportation service). For instance, from among the plurality of potential future battery states, the computing system can select a future battery state from which to generate the threshold battery state, as described herein.

Returning to FIG. 17A, at (2020), the computing system can transmit instructions to present data indicative of the threshold battery state via a user interface of the aircraft. For instance, the computing system can transmit instructions that indicate a computing device onboard the aircraft is to display (e.g., via a user interface presented on its display device) the determined threshold battery state.

### Example Computing System Components

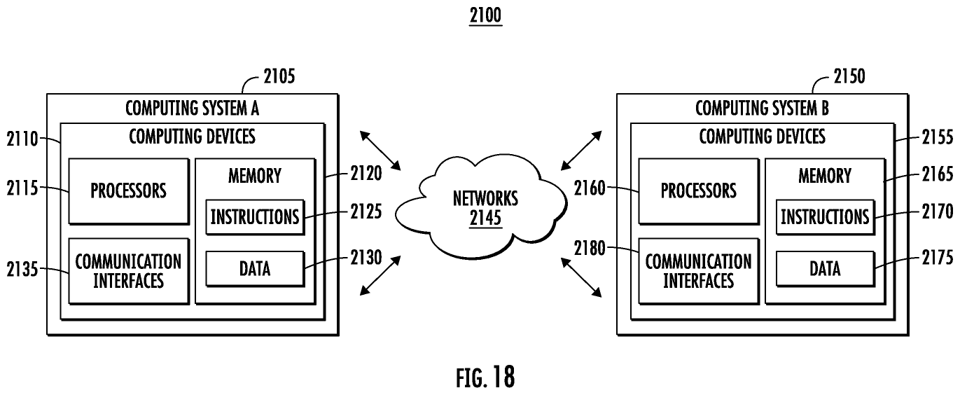

FIG. 18 depicts example system components of an example system 2100 according to example implementations of the present disclosure. The example system 2100 can include a computing system 2105 and a computing system 2150 that are communicatively coupled over one or more networks 2145. The computing systems 2105 and 2150 can represent, for example, computing systems that are onboard or offboard an aircraft, a cloud computing system, user computing system, or other systems/devices described herein.

The computing system 2105 can include one or more computing devices 2110. The computing devices 2110 of the computing system 2105 can include one or more processors 2115 and a memory 2120. The processors 2115 can be any suitable processing device (e.g., a processor core, a microprocessor, an ASIC, a FPGA, a controller, a microcontroller, etc.) and can be one processor or a plurality of processors that are operatively connected. The memory 2120 can include one or more non-transitory computer-readable storage media, such as RAM, ROM, EEPROM, EPROM, one or more memory devices, flash memory devices, etc., and combinations thereof.

The memory 2120 can store information that can be accessed by the processors 2115. For instance, the memory 2120 (e.g., one or more non-transitory computer-readable storage mediums, memory devices) can include computer-readable instructions 2125 that can be executed by the processors 2115. The instructions 2125 can be software written in any suitable programming language or can be implemented in hardware. Additionally, or alternatively, the instructions 2125 can be executed in logically and/or virtually separate threads on processors 2115.

For example, the memory 2120 can store instructions 2125 that when executed by the processors 2115 cause the processors 2115 to perform operations such as any of the processes/methods described herein or any of the operations and functions of any of the computing systems (e.g., aerial transportation platform system, ground transportation platform system, third party provider system, airspace system, computing system 1100, etc.) and/or computing devices (e.g., user devices, ground vehicle devices, aircraft devices, aerial facility devices facility operator user devices, computing device 1500, etc.), as described herein.

The memory 2120 can store data 2130 that can be obtained, received, accessed, written, manipulated, created, and/or stored. The data 2130 can include, for instance, any of the data/information described herein. In some implementations, the computing devices 2110 can obtain from and/or store data in one or more memory devices that are remote from the computing system 2105 such as one or more memory devices of the computing system 2150.

The computing devices 2110 can also include a communication interface 2135 used to communicate with one or more other systems (e.g., computing system 2150). The communication interface 2135 can include any circuits, components, software, etc. for communicating via one or more networks (e.g., 2145). In some implementations, the communication interface 2135 can include for example, one or more of a communications controller, receiver, transceiver, transmitter, port, conductors, software and/or hardware for communicating data/information.

The computing system 2150 can include one or more computing devices 2155. The computing devices 2155 can include one or more processors 2160 and a memory 2165. The one or more processors 2160 can be any suitable processing device (e.g., a processor core, a microprocessor, an ASIC, a FPGA, a controller, a microcontroller, etc.) and can be one processor or a plurality of processors that are operatively connected. The memory 2165 can include one or more non-transitory computer-readable storage media, such as RAM, ROM, EEPROM, EPROM, one or more memory devices, flash memory devices, etc., and combinations thereof.

The memory 2165 can store information that can be accessed by the processors 2160. For instance, the memory 2165 (e.g., one or more non-transitory computer-readable storage mediums, memory devices) can store data 2175 that can be accessed e.g., obtained, received, written, manipulated, created, stored, pulled, etc. The data 2175 can include, for instance, any data or information described herein. In some implementations, the computing system 2150 can obtain data from one or more memory devices that are remote from the computing system 2150.

The memory 2165 can also store computer-readable instructions 2170 that can be executed by the processors 2160. The instructions 2170 can be software written in any suitable programming language or can be implemented in hardware. Additionally, or alternatively, the instructions 2170 can be executed in logically and/or virtually separate threads on processors 2160. For example, the memory 2165 can store instructions 2170 that when executed by the processors 2160 cause the processors 2160 to perform any of the operations and/or functions described herein, including, for example, any of the processes/methods described herein or the operations and functions of any of the computing systems (e.g., aerial transportation platform system, ground transportation platform system, third party provider system, airspace system, computing system 1100, etc.) or computing devices (e.g., user devices, ground vehicle devices, aircraft devices, aerial facility devices facility operator user devices, computing device 1500, etc.), as described herein.

The computing devices 2155 can also include a communication interface 2180 used to communicate with one or more other systems. The communication interface 2180 can include any circuits, components, software, etc. for communicating via one or more networks (e.g., 2145). In some implementations, the communication interface 2180 can include for example, one or more of a communications controller, receiver, transceiver, transmitter, port, conductors, software and/or hardware for communicating data/information.

The networks 2145 can be any type of network or combination of networks that allows for communication between devices. In some implementations, the networks 2145 can include one or more of a local area network, wide area network, the Internet, secure network, cellular network, mesh network, peer-to-peer communication link and/or some combination thereof and can include any number of wired or wireless links. Communication over the networks 2145 can be accomplished, for instance, via a network interface using any type of protocol, protection scheme, encoding, format, packaging, etc.

FIG. 18 illustrates one example system 2100 that can be used to implement the present disclosure. Other computing systems can be used as well. Computing tasks discussed herein as being performed at computing devices remote from a vehicle/device can instead be performed at the vehicle/device, or vice versa. Such configurations can be implemented without deviating from the scope of the present disclosure.

### Additional Disclosure

The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices. Operations performed by one computing device/system (e.g., offboard a vehicle/aircraft) can be performed by another computing device/system (e.g., onboard a vehicle/aircraft), or vice versa.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art.

Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein. The term “or” should be understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. At times, elements can be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. can be performed before, after, or in parallel with another operation illustrated by a list identifier of (b), (ii), etc.

What is claimed is:

1. A computer-implemented method comprising:
accessing data associated with a first flight plan of a first flight;
based on the data associated with the first flight plan, computing a first expected power demand on an energy storage system of an aircraft for the first flight;
accessing data indicative of an initial battery state of the energy storage system of the aircraft;
computing, using a battery model, a first capability output based the first expected power demand on the energy storage system of the aircraft and the initial battery state of the energy storage system of the aircraft, wherein the first capability output is indicative of a range or an available time of flight of the aircraft for the first flight;
determining an ability of the aircraft to perform the first flight based on the first capability output;
generating an itinerary for the aircraft based on the ability of the aircraft to perform the first flight; and
transmitting, over a network, instructions associated with implementing the itinerary for the aircraft.

2. The computer-implemented method of claim 1, wherein it is determined that the aircraft is able to perform the first flight, and wherein generating the itinerary for the aircraft comprises adding the first flight to the itinerary for the aircraft.

3. The computer-implemented method of claim 1, wherein it is determined that aircraft is not able to perform the first flight, and wherein generating the itinerary for the aircraft comprises omitting the first flight from the itinerary for the aircraft.

4. The computer-implemented method of claim 1, further comprising:
accessing data associated with a second flight plan of a second flight;
computing a second expected power demand on the energy storage system of the aircraft based on the data associated with the second flight plan;
accessing data indicative of a predicted future battery state of the aircraft; and
computing, using the battery model, a second capability output based on the second expected power demand on the energy storage system of the aircraft and the predicted future battery state of the aircraft, wherein the second capability output is indicative of a future range or a future available time of flight of the aircraft for the second flight.

5. The computer-implemented method of claim 4, further comprising:
based on the second capability output, updating the itinerary for the aircraft to include the second flight.

6. The computer-implemented method of claim 4, further comprising:
based on the second capability output, computing one or more charging parameters for charging the energy storage system of the aircraft between the first flight and the second flight.

7. The computer-implemented method of claim 6, wherein the charging parameters are indicative of at least one of: a target level of charge, a target temperature, or charging infrastructure.

8. The computer-implemented method of claim 7, further comprising:
determining whether to include the second flight in the itinerary for the aircraft based on the charging parameters.

9. The computer-implemented method of claim 4, wherein the predicted future battery state of the aircraft is computed by the battery model based on the first expected power demand on the energy storage system of the aircraft and the initial battery state of the energy storage system of the aircraft.

10. The computer-implemented method of claim 1, wherein the data associated with the first flight plan of the first flight is indicative of one or more aircraft maneuvers for performing the first flight.

11. The computer-implemented method of claim 1, wherein the data associated with the first flight plan of the first flight is indicative of at least one of: (i) a route, (ii) an altitude, (iv) an environmental condition, (v) a noise constraint, or (vi) a speed.

12. The computer-implemented method of claim 1, further comprising:
accessing data indicative of a current battery state of the aircraft while the aircraft is performing the first flight;
computing, using the battery model, an updated capability output based on the current battery state of the aircraft and the battery model; and
adjusting the itinerary of the aircraft based on the updated capability output.

13. The computer-implemented method of claim 12, wherein adjusting the itinerary of the aircraft based on the updated capability output comprises at least one of: (i) adjusting a payload of the aircraft for a subsequent flight, (ii) adjusting one or more charging parameters for charging the aircraft after the first flight, or (iii) removing a subsequent flight from the itinerary of the aircraft.

14. The computer-implemented method of claim 1, wherein the first flight is associated with a multi-modal transportation service, the multi-modal transportation service comprises a first transportation leg comprising a first ground transportation service from an origin, an intermediate transportation leg comprising the first flight, and a second ground transportation service to a destination.

15. A computer-implemented method comprising:
accessing data associated with a flight plan of a flight currently being performed by an aircraft, wherein the flight is associated with a multi-modal transportation service;
computing an expected power demand on an energy storage system of the aircraft based on the data indicative of the flight plan;
accessing data indicative of a current battery state of the energy storage system of the aircraft;
computing, using a battery model, a predicted future battery state of the aircraft based on the expected power demand on the energy storage system of the aircraft and the current battery state of the energy storage system of the aircraft;
accessing data associated with the multi-modal transportation service;
determining an action associated with the multi-modal transportation service based on the predicted future battery state of the aircraft and the data associated with the multi-modal transportation service; and
transmitting, over a network, instructions indicative of the action associated with the multi-modal transportation service.

16. The computer-implemented method of claim 15, wherein the data associated with the multi-modal transportation service comprises at least one of: an itinerary of the aircraft, data associated with one or more other aircraft associated with the multi-modal transportation service, or data associated with one or more users of the multi-modal transportation service.

17. The computer-implemented method of claim 15, wherein the action associated with the multi-modal transportation service comprises at least one of: (i) an adjustment to the flight plan, (ii) an adjustment to an itinerary for the aircraft, (iii) an adjustment to an itinerary of another vehicle, (iv) an adjustment to an itinerary of a user, or (v) an adjustment to a ground transportation service.

18. The computer-implemented method of claim 15, further comprising:
determining one or more charging parameters for the aircraft based on the predicted future battery state of the aircraft; and
determining the action associated with the multi-modal transportation service based on the one or more charging parameters.

19. One or more non-transitory, computer-readable media storing instructions that are executable by one or more processors to cause the one or more processors to perform operations, the operations comprising:
accessing data associated with a flight plan of a flight;
based on the data associated with the flight plan, computing a power profile of an aircraft for the flight;
computing, using a battery model, a capability output based on the power profile and data indicative of an initial battery state of the aircraft;
generating an itinerary for the aircraft based on the capability output, wherein the itinerary is associated with a multi-modal transportation service; and
transmitting, over a network, instructions associated with implementing the itinerary for the aircraft.

20. The one or more non-transitory, computer-readable media of claim 19, wherein the power profile is indicative of an expected power demand on an energy storage system of an aircraft for the flight.
